(19) United States
(12) Patent Application Publication
(10) Pub. No.: US 2026/0339654 A1
(43) Pub. Date: Oct. 29, 2026

(54) HIGH AVAILABILITY MULTI-CONSUMER VERSIONING SYSTEM FOR RETRIEVING LISTS OF CHANGED OBJECTS

(71) Applicant: Hewlett Packard Enterprise Development LP, Spring, TX (US)

(72) Inventors: James Gregory, Bristol (GB); Dylan Farrer, Bath (GB)

(21) Appl. No.: 19/187,646

(22) Filed: Apr. 23, 2025

(51) Int. Cl. G06F 8/71

(52) U.S. Cl. CPC G06F 8/71

(57) ABSTRACT

In certain examples, a method includes receiving, at a messenger of nodes of a cloud information service, a subscription request corresponding to a resource type; providing the subscription request to versioners deployed on the nodes, where each versioner includes a cache ring corresponding to the resource type; determining, by a versioner, that the subscription request includes a version number for which the versioner includes an entry in its cache ring that includes an entry version number that is lower than the version number included in the subscription request; providing, in response to the determination and by each versioner, object identifiers corresponding to objects corresponding to entries having a higher version number than the version number included in the subscription request; requesting, by the messenger, object update information from a backing service for each object identified by the versioners; and providing, to a user interface, the object update information.

### BACKGROUND

Users of computing resources often desire to view information related to such resources. As an example, users may access a user interface to view information about resources that are implemented for the user in a cloud environment. However, such a user interface may disconnect from a service providing such information from time to time for various reasons. When the disconnection time is long enough, information regarding the resources may change. However, it may be inefficient to re-provide all resource-related information each time a user interface re-connects to an entity capable of providing resource-related information.

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 shows a block diagram of a system for providing information about cloud resources, in accordance with one or more examples disclosed herein;

FIG. 2 shows a block diagram of a high availability system for providing information about cloud resources, in accordance with one or more examples disclosed herein;

FIG. 3 illustrates an overview of an example method for providing information about cloud resources from a high-availability cloud information service, in accordance with one or more examples disclosed herein;

FIG. 4 illustrates a block diagram of a computing device, in accordance with one or more examples disclosed herein; and

FIG. 5 illustrates a block diagram of a computing device, in accordance with one or more examples disclosed herein.

### DESCRIPTION

A variety of resources (e.g., any physical resources and/or logical resources) may exist in a cloud environment. Examples of such resources include, but are not limited to, servers, network devices, enclosures, clusters, pods, containers, microservices, virtual machines, buckets (e.g., collections of stored data), and the like. Such resources may be implemented for and/or correspond to one or more users of the resources. A given user may access a user interface (e.g., a Data Services Cloud Console) in which the user may view information about the various resources (e.g., the aforementioned physical resources and/or logical resources) that exist in a cloud environment. Any number of users using any number of user interfaces may exist that desire to see information about all or any portion of the resources in a particular cloud environment.

The amount of information about the resources that correspond to a particular one or more users, and about which the user(s) desire(s) to view information, may be large. As an example, there may be hundreds, thousands, millions, and the like of resources in a particular cloud environment. Thus, each time a user accesses a user interface, either for a first time or any subsequent time after disconnecting from a previous session (e.g., intentionally, unintentionally as a result of a connectivity interruption, and the like), all of the information about all of the resources relevant to the user accessing the user interface (e.g., resources for which a user subscribes to receive updates) must be retrieved and provided to the user interface to be displayed to the user.

However, transmitting large amounts of information about resources in a cloud environment each time a user connects or reconnects to a cloud information service may be costly, in terms of compute resources, memory resources, network resources, time to transmit, expense, and the like.

Additionally, in some scenarios, the cloud information service that provides information related to resources may be deployed in a non-redundant manner. In such scenarios, if the non-redundant component (e.g., a node that processes and maintains update information used to provide resource information to users) of the cloud information service that interacts with the user interfaces goes down for any reason, the information about the updates to resource information may be lost, and thus must be rebuilt, which may also be costly in terms compute resources, memory resources, network resources, and time needed to service requests for information about resources of a cloud environment.

In order to address at least the aforementioned problems with providing information about resources in a cloud environment to users interested in viewing such information, examples disclosed herein provide techniques for reducing the amount of information about the resources that is transmitted to a user interface, while allowing the information available to the user to remain current relative to the state of the resources of the cloud environment. Additionally, techniques are disclosed herein for deploying components of a cloud information service in a manner that provides redundancy (e.g., high availability), thereby reducing the impact that failure of a component of the cloud information service may have on the ability of the cloud information service to process requests for information about resources.

In one or more examples, when a user (which may also be referred to as a subscriber) initiates (e.g., opens, executes, connects to, and the like) a user interface for viewing information about resources in a cloud environment for the first time, a subscription request may be sent to a cloud information service that is part of and/or operatively connected to the cloud environment in which the resources exist. Such subscription requests may also occur each time the user interface reconnects to the service (e.g., after a disconnection of any type). A user interface may remain subscribed after a subscription request has been sent, as long as the user interface remains connected to the cloud information service.

The cloud information service may be implemented on a set of nodes (e.g., three or more) executing in the cloud environment (e.g., executing within a container deployment of the cloud environment). In response to a subscription request from a user interface, the cloud information service may access information about the various resources, provide the information to the user, and provide updates for as long as the user interface maintains the connection, and, thus, remains subscribed.

In one or more examples, as discussed above, a cloud information service for providing resource information to subscribers in response to receipt of subscription requests may include a set of nodes (e.g., three or more nodes). Each node may include a versioner, and zero or more messengers.

The messengers may be configured to receive subscription requests, interact with the versioners to obtain information about updates to objects corresponding to resource instances in a cloud environment, interact with a backing service using the update information to obtain updated object metadata, and prepare and send resource information to subscribers.

The versioners may be configured to maintain sets of cache rings (discussed further below) for different resource types. A particular cache ring may include entries corresponding to updates of objects that correspond to resource instances (e.g., information indicating that an object metadata update has occurred) of a particular resource type. The versioners may also be configured to interact with a backing service (e.g., to receive object metadata update notifications) to become aware of updates to objects, and interact with the messengers to provide update information (e.g., information indicating that an update has occurred, rather than the actual updated information).

A node may be all or any portion of a computing device. As each node includes a versioner, the set of nodes includes a set of versioners, which may provide redundancy among the versioners, and, thus, redundancy among the sets of cache rings maintained by the versioners for the various resource types of the cloud environment.

The cloud information service may also include any number of messengers, distributed among all or any portion of the nodes, with the total number of messengers and the number of messengers per node being scalable depending on factors such as number of incoming subscription requests, resources available on the nodes, and the like.

In one or more examples, a messenger may receive a subscription request from a user interface when a user accesses the user interface to view information about resources in a cloud environment. Which particular messenger receives a given subscription request may be determined, for example, by a load balancing policy implemented for load balancing subscription requests among the messengers of the cloud information service.

In one or more examples, a subscription request corresponds to at least one resource type (e.g., buckets, enclosures, network devices, and the like). A messenger may receive any number of subscription requests from a given user interface, depending on how many different resource types the user is attempting to view information about. As an example, a user of a user interface may be seeking to view information about servers (e.g., a first resource type), and buckets (e.g., a second resource type), which results in the sending of two subscription requests, one for each resource type. In one or more examples, a subscription request identifies, at least, one or more resource types, and, for each resource type, may (or may not) also identify a version number associated with the last update received from the cloud information service corresponding to the respective resource type.

In one or more examples, when a messenger receives a subscription request, the cloud information service determines whether the subscription request includes a version number. As discussed above, a version number may be a number identifying the last version number received by the user interface corresponding to an update of an object of a particular resource type to which the subscription request pertains. More specifically, in one or more examples, the version number corresponds to the highest version number present in a set of cache rings maintained by the set of versioners on the set of nodes of the cloud information service the last time an update corresponding to the resource type was received by the user interface from the cloud information service.

In one or more examples, if the subscription request does not include a version number (e.g., the first time a user interface communicates a subscription request to the cloud information service), the cloud information service performs a full refresh (discussed further below), which includes obtaining current information about all instances of the resource type to which the subscription request pertains, and providing the information to the user interface, along with the highest version number presently in the set of cache rings (discussed further below) corresponding to the resource type. Thereafter, so long as the user interface remains subscribed for the resource type (e.g., maintains a connection to the cloud information service), the cloud information service will provide to the user interface, via one or more of the messengers, any updates that occur for any instances of the resource type.

In one or more examples, if the subscription request does include a version number (e.g., when a user interface is reconnecting to the cloud information service after a disconnect), the messenger may provide the version number to the set of versioners (along with any other relevant information from the subscription request, such as, for example an identifier of the subscribing user interface), which each determine whether all entries in their respective cache rings for the resource type include higher version numbers than the version number in the subscription request.

In one or more examples, if each cache ring for the resource type on each versioner includes only entries with a higher version number than the version number in the subscription request, the cloud information service performs a full refresh for the resource type. As an example, if a user interface has been disconnected from the cloud information service for a long enough period of time, the entries for updates to objects corresponding to resource instances of a resource type in a set of cache rings may have reached the ends of the cache rings and started again at the beginning of the cache rings, causing older updates (and their respective version numbers) to be overwritten, and thus no longer present in the set of cache rings.

In one or more examples, if one or more of the versioners determine that a cache ring maintained for the resource type includes at least some version numbers in entries in the cache ring that are the same as or lower than the version number included in the subscription request, then the cloud information service performs a partial refresh. In one or more examples, a partial refresh includes only sending to the user interface, via a messenger, updates that have occurred that caused entries in the cache rings that have a higher version number than the version number in the subscription request.

In one or more examples, such a partial refresh may reduce the amount of information that is transmitted to a user interface in response to a subscription request to provide the most current information on resources of the resource type of the subscription request by only sending information that has been updated since the last time the user interface received an update (which would have included the version number that was later included in the subscription request). This reduction in the amount of information transmitted may lead to a reduction in the compute resources, memory resources, network resources, and the like used by the cloud information service and the user interface, as well as a reduction in the network bandwidth used between the cloud information service and the user interface.

In one or more examples, each of the resources (e.g., servers, network devices, storage devices, enclosures, clusters, pods, containers, microservices, applications, virtual machines, buckets, and the like) in a cloud environment corresponds to a data object that includes information about the resource (e.g., metadata). As an example, an enclosure may have a firmware version, a certain number of components installed that are each in certain state (e.g., on, off, connected to or disconnected from a network, in a degraded state, and the like), and any other relevant information related to the enclosure, and the collection of such information about the enclosure may be considered an object. As another example, an application may be deployed in a Kubernetes container platform as a set of microservices implemented on a number of container pods, and all of the information about that application, or any portion thereof (e.g., the container platform, the microservices, pods, containers, devices on which such things are deployed, and the like), may be considered an object. As another example, a user may have created any number of buckets (e.g., Amazon S3 buckets) for storing information of any type, and information about those each of the buckets (e.g., bucket size, space left in bucket, access policy for bucket, and the like) may be considered as objects.

Thus, as used herein, an object may refer to a collection of metadata about a resource (e.g., an enclosure, a container deployment, a bucket, any physical or logical component, and the like) in a cloud environment. In one or more examples, objects may be grouped into resource types. For example, an enclosure resource type may refer to all objects corresponding to enclosures, a container resource type may refer to a collection of objects corresponding to container deployments, a bucket resource type may refer to a collection of objects corresponding to buckets, and the like.

In one or more examples, a cloud information service is configured to create and maintain cache rings for each resource type in a cloud environment using a set of versioners respectively deployed on a set of nodes of the cloud information service.

The cache rings for a given resource type may be distributed across a set of versioners deployed on a set of nodes (e.g., three or more) to provide redundancy. In such a scenario, each object of a given resource type may be associated with a primary node and a secondary node of the set of nodes that include a cache ring for the resource type, with the total number of objects of the resource type being substantially equitably distributed among the set of nodes as primary nodes for the objects.

Thus, in one or more examples, for a given resource type, the cloud information service may implement a set of cache rings maintained by a set of versioners on a set of nodes, with one versioner being a primary owner versioner, one versioner being a secondary owner versioner, and other versioners being non-owner versioners for a particular object corresponding to a particular instance of a resource of a resource type to which the set of cache rings corresponds, with the primary ownership (and secondary ownership) of objects being distributed across the set of nodes, and, thus, across the set of versioners executing on such nodes. In one or more examples, the distribution of ownership of objects of a particular resource type across the set of versioners on the set of nodes may improve the redundancy and resiliency of the cloud information service, and help to improve the availability of information from the cloud information service (e.g., thereby making it ‘high-availability’).

There may be any number of cache rings maintained by a versioner on a given node, depending on how many resource types exist in the cloud environment. The following description, for the sake of clarity, will focus on one set of cache rings for one resource type. However, one of ordinary skill in the art will appreciate that the description of a set of cache rings applies to any number of sets of cache rings for any number of resource types in a cloud environment, and that a cloud information service may use the various sets of cache rings to provide information to a user interface about any number of resource types.

In one or more examples, as discussed above, each node of the cloud information service may implement a versioner, which maintains one cache ring of a set of cache rings corresponding to a particular resource type. Thus, a set of cache rings for a particular resource type may be maintained, respectively, by a set of versioners deployed on a set of nodes of the cloud information service. All or any portion of the nodes may further include zero or more messengers, as discussed above and further below.

In one or more examples, a versioner on a node maintains a cache ring that include entries corresponding to updates of objects corresponding to instances of resources of a resource type. In one or more examples, the versioners are configured to communicate with a backing service (e.g., from which update information is received) and with the one or more messengers.

In one or more examples, as discussed above, the messengers are configured to receive subscription requests, interact with the versioners to obtain information about object updates, and interact with the backing service(s) to obtain the actual object metadata that was updated, which is provided to subscribers (e.g., when a subscription request is received for information about a particular resource type). Each node may include one versioner, and may or may not include one or more messengers. The total number of messengers may be distributed across the set of nodes of the cloud information service in any manner, and can be scaled up or down depending on the need (e.g., number of incoming requests), resources of the nodes, and the like.

A particular cache ring maintained by a versioner on a node may be implemented in memory (e.g., rather than some form of persistent storage). A cache ring may have entries that are added by the versioners as information about updates are received from the backing service. The versioners may be provided information each time an object corresponding to a resource in the cloud environment is updated.

As an example, when the firmware of an enclosure is updated, the object maintained by a backing service and corresponding to the enclosure may be updated to reflect the new firmware version. As another example, when access permissions for a bucket are updated, the object corresponding to the bucket may be updated to reflect the new access policy. As another example, when the number of pods of containers used to implement an application increases, the object corresponding to the container deployment may be updated with the new number of pods. Other updates to the resources may cause updates to corresponding objects without departing from the scope of examples disclosed herein. In one or more examples, each such update may cause the backing service to communicate to the set of versioners information a notification indicating that an update to the object has occurred.

The versioners may receive information about object updates using any manner of receiving information. As an example, the cloud information service may receive information about container deployments via a Kubernetes application programming interface (API) providing information based on a custom resource definition (CRD). As another example, various APIs may exist and be configured to provide information about other resources (e.g., buckets, physical devices, logical components, and the like). In general, the collection of entities (e.g., APIs, monitoring tools, management tools, and the like) providing information about object updates to the cloud information service (e.g., the versioners and/or the messengers) may be collectively referred to as a backing service.

In one or more examples, each time the versioners are notified that an object has been updated, the notification may be provided (e.g., from an API of a backing service maintaining objects and monitoring object changes) to each versioner on each of a set of nodes maintaining a cache ring for the resource type to which the object corresponds. Of the set of versioners, one of the versioners may be a primary versioner for the particular object, and another versioner may be the secondary versioner for the object, with all other versioner being non-owner versioners for the object.

Which versioner is the primary versioner for the object, and which versioner is the secondary versioner for an object, may be deterministically decided using any suitable technique. As an example, each object may have a unique identifier (e.g., ‘buckets/bucket-0’). In such an example, the primary versioner for the object may be determined by executing a hash function on the unique object name, and taking the result modulo the number of nodes in the set of nodes. The secondary versioner for the object may be determined, for example, by adding one to an identifier of the node of the primary versioner, so that the secondary versioner is always on the next node in a listing of nodes after the node of the primary versioner (e.g., when the primary versioner on node 0, the secondary versioner is node 1, when the primary versioner is on node 1, the secondary versioner is on node 2, and the like).

In one or more examples, when an object is updated, the backing service is configured to send a notification to each of the set of versioners of the cloud information service. The notification may include an attempt number indicating a number of times the backing service has sent the notification before receiving an acknowledgement of receipt by a versioner (discussed further below).

In one or more examples, in response to receiving a notification of an object update, which includes a unique identifier of the object, each versioner determines whether it is a primary owner, secondary owner, or a non-owner of the object (e.g., by performing the aforementioned hash function calculations using the unique object identifier).

In one or more examples, if a versioner is not the primary or secondary owner for the object (e.g., the versioner is a non-owner versioner for the object), the received update may be discarded by the non-owner versioner. Additionally, a global version number for updates of objects of the resource type may be incremented on the non-owner versioner, so that the versioner maintains a highest version number for any update to any object of the resource type, even when the versioner is not the primary or secondary owner for the object corresponding to the update.

In one or more examples, if a versioner determines that it is the primary owner for the object (e.g., by performing the aforementioned hash function calculations using the unique object name), the primary owner versioner may add an entry corresponding to the update to a cache ring maintained by the versioner for the resource type to which the object corresponds. The entry may include, at least, an identifier of the object, a version number of the entry added to the cache ring, and other relevant information, such as the update type (e.g., update, deletion, refresh, separator, and the like, discussed further below). In one or more examples, the version number represents a new entry in the cache ring, and does not correspond to any particular object of the resource type.

In one or more examples, the primary owner versioner may also send an acknowledgement to the backing service indicating receipt of the update. In one or more examples, if the primary owner versioner does not send such an acknowledgement (e.g., because the node on which the primary owner versioner is deployed is down, in a degraded state, and the like), the backing service may increment an update notification attempt counter maintained by the backing service for the update, and re-send the notification of the update to all versioners. In one or more examples, each re-send will include an incremented attempt number corresponding to the number of attempts of sending the notification that have been performed by the backing service, which will continue until a versioner responds with an acknowledgement of receipt of the update.

In one or more examples, if a versioner determines that it is the secondary owner for the object (e.g., by performing the aforementioned hash function calculations using the unique object name), the secondary owner versioner may add an entry corresponding to the update (similar to the adding of an entry discussed above on the primary owner versioner) to a cache ring maintained by the versioner for the resource type to which the object corresponds, unless the secondary owner versioner has already added the entry (e.g., in a case where the backing service is re-sending a previously sent object update notification after not receiving an acknowledgement from the primary owner versioner), in which case the secondary owner versioner may discard the update.

In one or more examples, the secondary versioner is configured to monitor the update notification attempt number included in the notification. The secondary owner versioner may be pre-configured with a threshold attempt number (e.g., three, five, eight, or any other number). In one or more examples, if the secondary owner versioner determines that an attempt number in a notification has reached the threshold attempt number, the secondary owner versioner may respond by sending an acknowledgement of receipt of the notification to the backing service (e.g., because the primary owner versioner has failed to do so for some reason).

In one or more examples, when an entry is added to a cache ring of a primary owner versioner for an object corresponding to a resource of a resource type, and the primary owner versioner has sent an acknowledgement of receipt of the notification of the update to the backing service, the primary owner versioner may send a notification of the update to a messenger, along with a subscriber list. In one or more examples, a subscriber list is a list of all current subscribers for the resource type to which the cache ring corresponds. In one or more examples, each versioner maintains a subscriber list, based on subscription requests for the resource type provided from messengers (which received the subscription requests from user interfaces). Thus, in one or more examples, each versioner maintains the same subscriber list for a given resource type.

In one or more examples, the messenger to which a notification of the update is sent from a versioner may be determined by a load balancing policy implemented to load balance update notifications among the messengers deployed on the various nodes of the cloud information service. In one or more examples, in response to receiving an update notification, the selected messenger may use an object identifier included in the update notification to query the backing service for the metadata update that caused the cache ring update (e.g., the current metadata in the object), and, after receiving the updated metadata, communicate the updated metadata to the subscribed user interfaces (identified by the subscriber list received along with the update notification), along with the version number of the entry added to the cache ring of the primary owner versioner (which is also the highest version umber of any entry in the set of cache rings maintained on the set of nodes by the set of versioners).

In one or more examples, when the primary owner versioner fails to send an acknowledgement to the backing service indicating receipt of an update notification after the threshold attempt number, and the secondary owner versioner has instead sent the acknowledgement to the backing service, the secondary owner versioner may send the update notification to a selected messenger (as described above with regards to the primary owner versioner), and the messenger may perform the same actions to provide the update to the subscribed user interfaces. Thus, in one or more examples, user interfaces that have previously sent a subscription request corresponding to a particular resource type, and have maintained a connection to the cloud information service (e.g., maintained an active subscription), may receive updates to objects of the resource type on an on-going basis.

In one or more examples, when a messenger receives a subscription request, the subscription request, or at least certain information included therein, is communicated to each of the set of versioners. In one or more examples, the versioners update their respective copies of the subscriber list, if needed, to include the subscriber identified in the subscription request. Thus, the subscriber list may be maintained by the versioners, rather than by any particular messenger, thereby allowing the messengers to remain stateless, as the stateful information necessary for implementing the cloud information service disclosed herein (e.g., update information, subscriber list, object metadata, and the like) may be maintained by the versioners and/or the backing service, rather than by the messengers.

In one or more examples, as discussed above, if the subscription request does not include a version number, or if the subscription request include a version number than is lower than any version number of any entries of the set of cache rings for the resource type to which the subscription request corresponds, a full refresh is performed. In one or more examples, a full refresh includes information for all objects of resources corresponding to the resource type.

To facilitate a full refresh, each primary owner versioner may respond to such a subscription request with a list of object identifiers for which a respective versioner is a primary owner. Such responses provide the messenger with a list of the object identifiers for the resource type, which the messenger may use to query the backing service, in order to obtain the current metadata included in objects corresponding to resources of the resource type, which the messenger may then transmit to the user interface in response to the subscription request.

In one or more examples, when a full refresh is performed, the cloud information service may add a set of entries to the set of cache rings corresponding to a resource type to which the updated object belongs, for both the cache ring of the primary owner versioner, and for the secondary owner versioner of the set of versioners having cache rings for the resource type. The set of entries added when a full refresh is performed start with a first separator type entry, then a refresh type entry for all objects of the resource type, and then a second separator type entry, thereby differentiating the update entries for the full refresh from other update entries in the set of cache rings.

In one or more examples, each update to an object of the resource type to which the set of cache rings correspond causes the cloud information service to add an entry to the primary and secondary cache rings (as discussed above), up to the configured maximum size of the cache ring (e.g., hundreds, thousands, millions, and the like of entries). In one or more examples, each entry added to a cache ring by the cloud information service includes a unique identifier (e.g., a unique name, a universally unique identifier (UUID), and the like) of the object that was updated, and a version data item. The version data item may include an encoding of the type of entry (discussed below), as well as a representation of the version number for the entry. As an example, the version data item may be a thirty-two bit number, in which the first two bits are used to encode one of four possible entry types and the remaining thirty bits are used to encode the integer value of the version number. In one or more examples, each entry added by the cloud information service to a set of cache rings includes a version number that is increased (e.g., by one) from the previous entry added to the set of cache rings.

As discussed above, a set of cache rings corresponds to a resource type, and there may be any number of objects of that resource type (e.g., millions of buckets, each corresponding to separate objects). In one or more examples, an update to any object of that resource type causes the cloud information service to add an entry to the appropriate cache ring(s) of the set of cache rings maintained by the set of versioners. In one or more examples, the version number represents a new entry in the set of cache rings, and does not correspond to any particular object of the resource type.

In one or more examples, the primary owner versioner and the secondary owner versioner will each have an entry including the version number for the added entry, and each of the non-owner versioners will have incremented their respective copies of the global version number, so that each versioner is aware of the highest version number of any entry added to any cache ring of the set of cache rings.

In one or more examples, there are four types of entries that may be added to the set of cache rings corresponding to a given resource type. In one or more examples, the first type of entry is an update. In one or more examples, an update is when the information in an object (e.g., metadata corresponding to a resource in a cloud environment) changes. As an example, when the firmware of a network component of an enclosure changes, the object may be changed to reflect a version number of the new firmware. In one or more examples, the second type of entry is a deletion. As an example, a resource may be removed from the cloud environment (e.g., a physical device is removed, a container pod is deleted, a bucket is deleted, and the like), and the object corresponding to that resource is deleted, leading to the adding of a deletion type entry to the set of cache rings corresponding to the resource type of the object that was deleted.

In one or more examples, the remaining two entry types are separator entries and refresh entries. In one or more examples, separator and refresh are entry types used whenever a full refresh is performed. In one or more examples, as discussed above, a full refresh is performed whenever a subscription request is received that requires all objects of a resource type corresponding to a set of cache rings to be provided to the user interface from which the subscription request was received. In one or more examples, as discussed above, a subscription request is received whenever the user interface is accessed by the user so that the user may view information about resources of a cloud environment. As such, a subscription request may be received when a user first uses the user interface and connects to a cloud information service, and also each time a user reconnects to the cloud information service after previously disconnecting from the cloud information service.

As discussed above, an initial subscription request may not include a version number. In one or more examples, if a subscription request is received that has no version number, a full refresh is performed. In one or more examples, to perform a full refresh, each versioner responds to the subscription request received from the messenger with a list of object identifiers for which the respective versioner is a primary owner versioner. Thus, unless there is an issue with one or more of the versioners (e.g., the node on which the versioner executes has failed), the collective responses from the set of versioners include a comprehensive listing of all objects of the resource type to which the subscription request corresponds. In such a scenario, the messenger may then use the collective object identifiers from the set of versioners to query the backing service for the object metadata for each of the objects of the resource type. In one or more examples, the object information for each of the objects of the resource type is then transmitted to the user interface from which the subscription request was received, thereby allowing the user interface to present a current set of resource information to a user.

In some examples, performing the full refresh may include updating the cache rings of the versioners to ensure that the cache rings include a current entry for each object of the resource type. In one or more examples, the cloud information service adds an entry to the set of cache rings with a separator type, then entries for all objects of the resource type to which the cache rings correspond, with each such entry having a refresh entry type, and then another entry with a separator entry type, with the first separator entry, each of the refresh entries, and the second separator entry each having an increasing version number, and representing a full refresh.

In one or more examples, the cloud information service then checks to determine whether any updates to any objects have occurred during the time full refresh was being performed, and the separator and refresh entries were being added to the cache ring. In one or more examples, if there were no updates that occurred during that time, the messenger sends the information corresponding to each refresh entry to the user interface in one or more messages of any type (e.g., data packets over a network). In one or more examples, the information corresponding to a refresh entry is the metadata about the resource to which an object corresponds, which the messenger obtains from the backing service. In one or more examples, the messenger uses the unique identifiers (which are included in the entries in the cache rings) of the objects to obtain the information from the objects using whatever method of obtaining such information is appropriate for the resource type (e.g., Kubernetes API for objects corresponding to a container deployment, other APIs for objects corresponding to physical resources, and the like). In one or more examples, the information from the objects is sent via one or more messages, and used to update the user interface to display the information to the user.

In one or more examples, if a messenger does not receive a response from one or more versioners in response to a subscription request, then the messenger may request update information from secondary owner versioners for each object owned by the one or more primary owner versioners that failed to respond. As discussed above, the secondary owner versioner may be determined relative to the primary owner versioner. As such, the request from the messenger may be sent to the secondary owner versioner by the messenger. As an example, when the secondary owner versioner is the versioner deployed on a node having an identifier incremented by one from an identifier of the primary owner versioner node, the request may be sent to the versioner on that node.

In one or more examples, the secondary owner versioner, which has maintained a current set of updates in its cache ring for objects for which it is the secondary owner (as discussed above), may respond to such a request with the update information for the object, thereby allowing the messenger to have a complete list of updated objects, even when the primary owner versioner of the object has failed to respond (e.g., because it has failed, become disconnected, and the like), providing redundancy among the set of versioners for any object of the resource type.

In one or more examples, a similar process may be performed when a subscription request is received that include a version number, where at least one versioner includes a version number lower than the version number received in the subscription request. Specifically, each versioner may respond to the messenger with a list of object identifiers corresponding to cache ring entries having a version number higher than the version number included in the subscription request, which, in aggregate, may be less than all of the objects of the resource type. The messenger service may then use the reduced set of object identifiers to query the backing service to obtain the object updates only for the objects that have been updated after the update that led to an entry having the version number included in the subscription request. The updated resource information for this reduced set may then be provided as an update to the user interface, which may be less information than would have been provided had a full refresh been performed.

In one or more examples, the primary and secondary owner versioners are synchronized so that they remain as current as possible, even when one or the other goes down for any reason. To facilitate such synchronization, the primary and secondary owner versioners may correspond periodically, or based on the occurrence of an event (e.g., one of the nodes including one of the versioners going down, and then coming back up) to determine if either of the versioners do not have the same highest version number for any entries for objects for which they are the primary or secondary owner versioner. In the event that the highest version number included in an entry for an object between the primary and secondary owner do not match, each of the primary and secondary owner versioners may add an entry corresponding to whatever entry between the two versioners for a given object has the highest version number, such that the two versioners have the same highest version number for entries corresponding to a particular object.

Certain examples set forth in this disclosure may allow any number of user interfaces to receive and maintain current information about resources in a cloud environment without having to be sent all information about the resources each time the user interface connects to a cloud information service seeking the resource information via a subscription request. In one or more examples, the amount of information being transmitted to the user interface from the cloud information service is reduced by maintaining a set of cache rings distributed among a set of versioners on a set of nodes for each resource type in the cloud environment, where entries in the cache rings include an object identifier, an entry type, and a version number, which allows the cloud information service to only provide information about objects that have been updated or deleted, and only performing a full refresh of all information when a user interface connects to the cloud information service for the first time, or when the version number received in a subscription request as part of a reconnect is no longer in the cache ring. Additionally, the cloud information service may be improved by providing redundancy of update information through having a primary owner versioner and a secondary owner versioner for each object of a particular resource type, such that even when one of the owners has failed in some way, the cloud information service remains able to provide the update information to the user interface. Additional redundancy and resiliency may be provided by distributing a set of stateless messengers across the set of nodes, such that the failure of any node does not eliminate the ability of the cloud information service to set updates via the messengers.

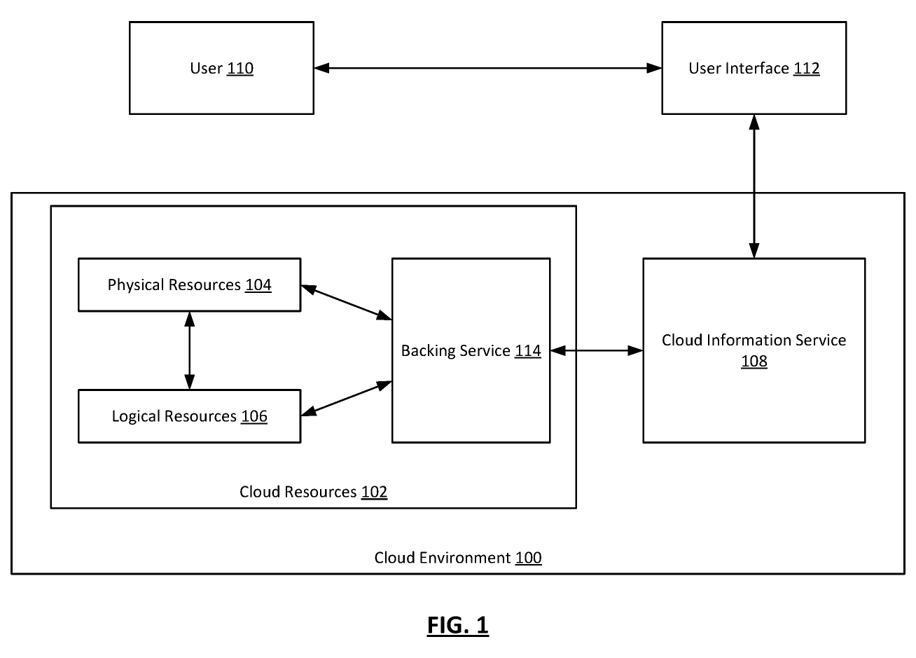

FIG. 1 shows a block diagram of a system for providing information about cloud resources, in accordance with one or more examples disclosed herein. As shown in FIG. 1, the system may include a cloud environment 100. The cloud environment 100 may include cloud resources 102 and a cloud information service 108. The cloud resources may include physical resources 104, logical resources 106, and a backing service 114. The system may also include a user 110 and a user interface 112. Each of these components is described below.

In one or more examples, the cloud environment 100 is a collection of any number of computing devices and other components in which a cloud computing resources are deployed, and which may host any number of cloud-based applications, as-a-Service (aaS) products (e.g., Software aaS (SaaS), Infrastructure aaS (IaaS), Platform aaS (PaaS), Storage aaS (STaaS), and the like), microservices, container platforms, virtualization environments, infrastructure components, power supplies, racks, enclosures, environment controls, physical spaces, wiring, and the like. The cloud environment 100 may include one or more private clouds, public clouds, and/or hybrid clouds. The cloud environment 100 may be located in a single physical location, or spread among any number of separate locations. The cloud environment 100 may be owned or otherwise maintained by a particular entity, or be provided by any number of separate entities without departing from the scope of examples disclosed herein.

In one or more examples, the cloud environment 100 includes the cloud resources 102. In one or more examples, the cloud resources 102, as used herein, refer to the portion of the cloud environment 100 that may be used or otherwise accessed by any number of users (e.g., the user 110) of the cloud environment 100. As an example, the cloud resources 102 may include a portion of the cloud environment 100 that is used by users to access aaS offerings, composable infrastructure, virtualization environments, microservices, storage and backup services, database management, and the like.

In one or more examples, the cloud resources 102 include the physical resources 104. In one or more examples, the physical resources 104 include any physical (e.g., hardware) components of the cloud resources, such as, for example, computing devices, network components, storage components, racks, enclosures, and the like.

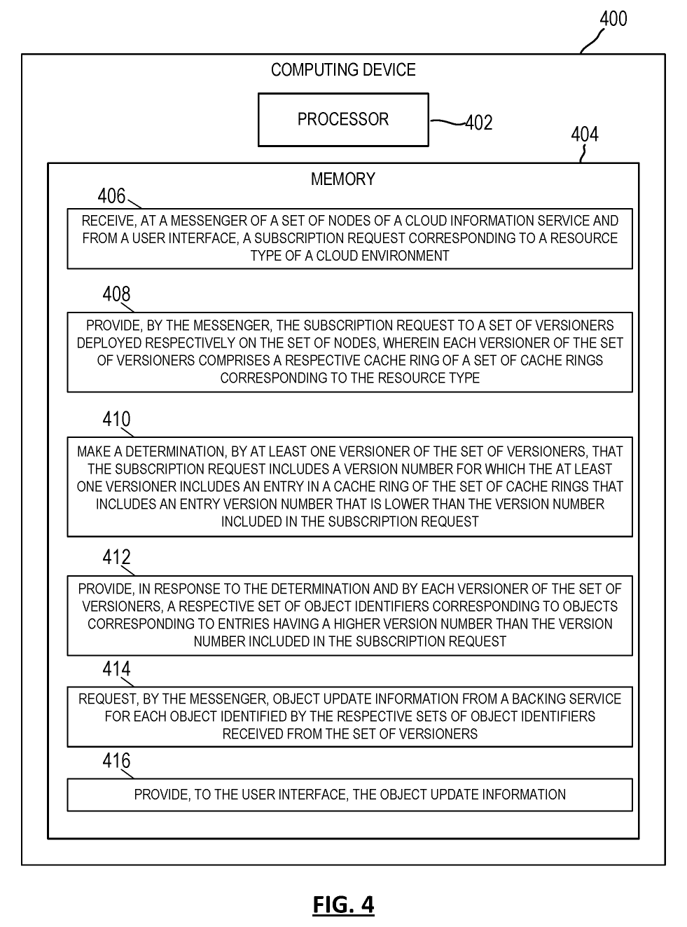

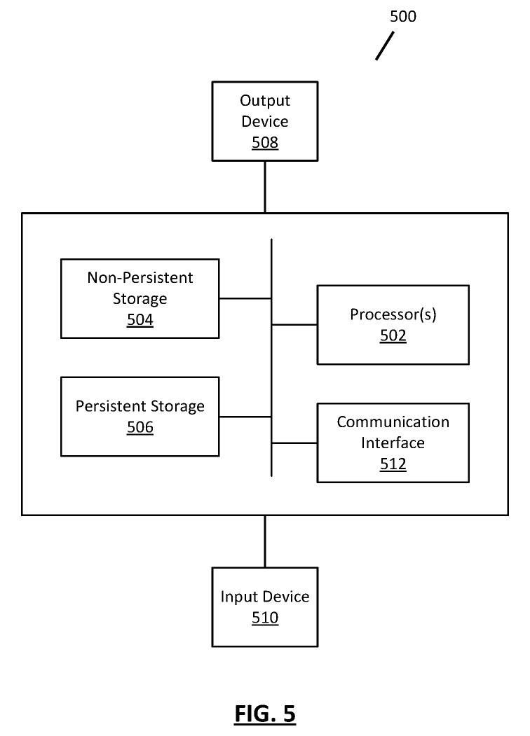

In one or more examples, as used herein, a computing device may be any single computing device, a set of computing devices, a portion of one or more computing devices, or any other physical, virtual, and/or logical grouping of computing resources. Non-limiting examples of a computing device are shown in FIGS. 4, and 5, which are described below. In one or more examples, a computing device may be any device of any type that is configured to host all or any portion of one or more operating systems, applications, microservices, clustered environment services, storage services, network services, and/or any other computing function, which may include executing instructions, performing operations, executing functions, performing computations, and the like.

In one or more examples, a computing device is any device, portion of a device, or any set of devices capable of electronically processing instructions and may include, but is not limited to, any of the following: one or more processors (e.g. components that include circuitry) (not shown), memory (e.g., random access memory (RAM)) (not shown), input and output device(s) (not shown), non-volatile storage hardware (e.g., solid-state drives (SSDs), persistent memory (Pmem) devices, hard disk drives (HDDs) (not shown)), one or more physical interfaces (e.g., network ports, storage ports) (not shown), any number of other hardware components (not shown), and/or any combination thereof. As used herein, a processor may be any component that can be configured to execute operations. Examples of a processor include, but are not limited to, central processing units (CPUs), multi-core CPUs, application-specific integrated circuits (ASICs), accelerators (e.g., graphics processing units (GPUs)), field programmable gate arrays (FPGAs), and the like. Other types of processors may be used without departing from the scope of examples disclosed herein, such as, for example, the various processors included in the description of FIG. 5, below.

Examples of computing devices include, but are not limited to, a server (e.g., a blade-server in a blade-server chassis, a rack server in a rack, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, and the like), a network device (e.g., switch, router, multi-layer switch, access point, and the like), a virtual machine, a virtualized computing environment, a logical container (e.g., for one or more applications), a container pod, an Internet of Things (IoT) device, an array of nodes of computing resources, a supercomputing device, a data center or any portion thereof, and/or any other type of computing device. As one of ordinary skill in the art will appreciate, any of the aforementioned examples of computing devices necessarily require at least some hardware components. As an example, a virtual machine, a container, and/or a container pod, when considered herein as a computing device, or a portion of a computing device, includes the underlying hardware on which the virtual machine, container, and/or a container pod executes.

In one or more examples, any or all the aforementioned examples may be combined to create a system of such devices, or may be partitioned into separate logical devices, which may individually or collectively be referred to as a computing device. Other types of computing devices may be used without departing from the scope of examples described herein. The physical resources 104, the logical resources 106, the cloud resources 102, the cloud environment 100, the backing service 114, the cloud information service 108, and/or the user interface 112 may include and/or be implemented using any number and/or type of such computing devices in any arrangement and/or configuration without departing from the scope of examples disclosed herein.

In one or more examples, the storage and/or memory of a computing device or system of computing devices, or any other component of the cloud environment 100, may be and/or include one or more data repositories for storing any number of data structures storing any amount of data (e.g., information). In one or more examples, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more examples, any storage and/or memory of a computing device, system of computing devices, or any other component of the cloud environment 100 may be considered, in whole or in part, as non-transitory computer readable mediums storing software and/or firmware.

Such software and/or firmware may include instructions which, when executed by the one or more processors (not shown) and/or other hardware (e.g., circuitry) of a computing device and/or system of computing devices, cause the one or more processors and/or other hardware components to perform operations in accordance with one or more examples described herein.

The software instructions may be in the form of computer readable program code to perform methods, processes, and the like of examples described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

The physical resources 104 may include any number of computing devices, any number of which may be collectively considered a computing device as used herein. All or any portion of the computing devices may be the same type or be different types of computing devices.

In one or more examples, the cloud resources 102 include the logical resources 106. In one or more examples, as used herein, the logical resources 106 include any software, firmware, applications, container platforms, virtualization environments, microservices, communication protocols, storage buckets, and the like. that execute, at least in part, using the physical resources 104.

As an example, in one or more examples, all or any portion of the logical resources 106 may be managed, at least in part, by a container platform (not shown), such as, for example, Kubernetes. In one or more examples, a container platform includes a control plane (not shown). A control plane of a container platform may include various components for managing the logical resources (e.g., one or more API servers, controllers, schedulers, and the like). The control plane may, for example, be implemented on one or more master nodes, each of which may be a computing device (discussed above).

In one or more examples, the cloud resources 102 may host any number of cloud-based applications as part of the logical resources 106, which may be implemented using a microservice architecture that includes any number of application microservices, as well as various other microservices (e.g., a user interface microservice, any number of common microservices, and the like) and various communication components that allow the various microservices to interact with other microservices, other parts of the cloud resources 102, the cloud environment 100, and/or entities and/or devices outside the cloud environment 100.

In one or more examples, a microservice may be implemented using any number of containers, container pods, and the like. Each microservice may implement a particular service component that makes up part of an overall cloud-based application deployed as at least a portion of the logical resources 106.

In one or more examples, the logical resources 106 may include common microservices, which may be a set of services that are common to all or any portion of the other microservices of the one or more cloud-based applications deployed using a microservice architecture in the cloud environment 100. Examples of common microservices include, but are not limited to, database services, authorization services, workflow orchestration microservices, auditing microservices, management microservices, and the like.

In one or more examples, the physical resources 104 and/or the logical resources 106 include various communication components. In one or more examples, as used herein, communication components include physical and/or logical devices and/or components that implement any number of communication protocols that allow communication within the cloud resources 102. As an example, various communication protocols may include, but are not limited to, Representational State Transfer (REST) protocol, remote procedure call (RPC) frameworks (e.g., gRPC), Kafka protocol, and the like, as well as other underlying protocols that may be used in communications, such as hypertext transfer protocol (HTTP), transmission control protocol (TCP), user datagram protocol (UDP), and the like. Such protocols may be used for communicating data, commands, and the like. Communication components of the logical resources 106 may, for example, be implemented, at least in part, using network devices of the physical resources 104.

In one or more examples, the logical resources 106 may include any number (e.g., hundreds, thousands, millions) of buckets (e.g., Amazon S3 buckets). A bucket may be a cloud storage container for storing information of any type or amount. The logical resources 106 may include any other types of logical entities (e.g., virtual machines, virtual network devices, virtual storage devices, hypervisors, management software, and the like) without departing from the scope of examples disclosed herein.

Although not shown in FIG. 1, in one or more examples, each of the physical resources 104 and/or logical resources 106 of the cloud resources 102 in the cloud environment 100 correspond to a data object (which may be stored anywhere in the cloud environment 100) that includes information about the resource (e.g., metadata). The various objects may be maintained, managed, accessed, and the like by the backing service 114 (discussed further below) of the cloud resources 102.

As an example, a blade server enclosure may have a firmware version, a certain number of components installed that are each in certain state (e.g., on, off, connected to or disconnected from a network, in a degraded state, functioning normally, and the like), any other relevant information related to the enclosure, and the like, and the collection of such information about the enclosure (e.g., enclosure metadata) may be considered an object.

As another example, a cloud-based application may be deployed in a Kubernetes container platform as a set of microservices implemented on a number of container pods, each having any number of containers, and all of the information about that application, or any portion thereof (e.g., the container platform, the microservices, pods, containers, devices on which such things are deployed, and the like), may be considered an object.

As another example, a user may have created any number of buckets (e.g., Amazon S3 buckets) for storing information of any type, and information about each of the buckets (e.g., bucket size, space left in bucket, access policy for bucket, and the like) may be considered as objects. Thus, as used herein, an object may refer to metadata about a resource (e.g., an enclosure, a container deployment, a bucket, any physical or logical component, and the like) in the cloud resources 102.

In one or more examples, objects may be grouped into resource types. For example, an enclosure resource type may refer to all objects corresponding to enclosures, a container resource type may refer to a collection of objects corresponding to container deployments, a bucket resource type may refer to a collection of objects corresponding to buckets, and the like.

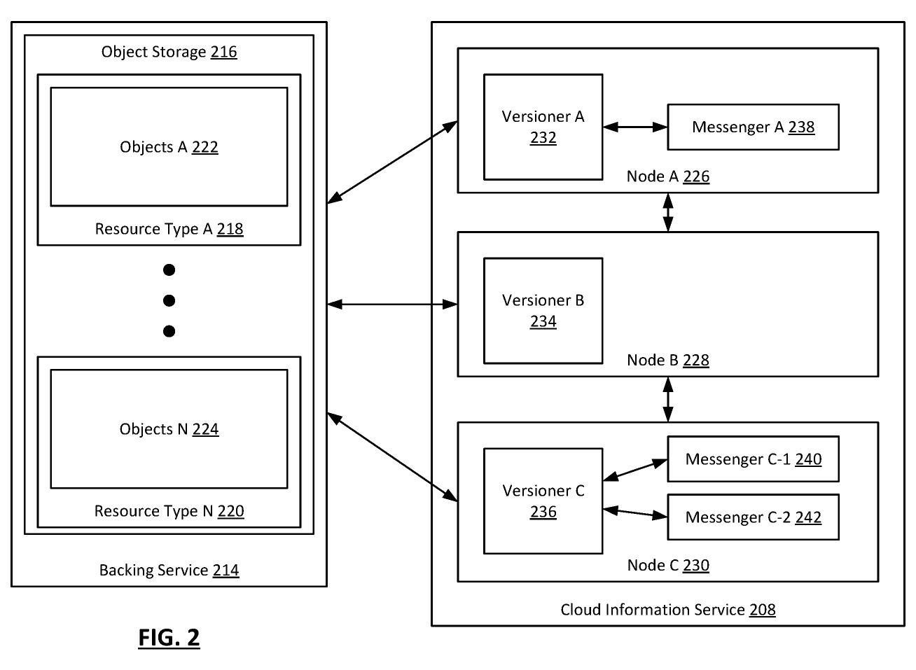

In one or more examples, the cloud resources 102 may include the backing service 114. In one or more examples, the backing service 114 is any hardware (e.g., circuitry), or software executing on hardware, that is configured to provide notifications of object updates to versioners (discussed further in the description of FIG. 2, below) the cloud information service 108, as well as metadata from objects to messengers (discussed further in the description of FIG. 2, below) of the cloud information service 108. As such, the backing service 114 may include various APIs, monitoring tools, management tools, and the like, which are configured to monitor the physical resources 104 and the logical resources 106 of the cloud resources 102, and maintain objects corresponding to resource instances, including updating such objects when information (e.g., metadata) about the resources changes, deleting objects when resources are removed, and the like.

In one or more examples, the backing service 114 may be implemented, at least on part, on a computing device (discussed above). Although FIG. 1 shows the backing service 114 as included in the cloud resources 102, in some examples, the backing service 114 may be separate from, and operatively connected to, the cloud resources 102 without departing from the scope of examples disclosed herein. The backing service is discussed further in the description of FIG. 2, below.

In one or more examples, the cloud environment 100 includes the cloud information service 108. In one or more examples, the cloud information service is any hardware, software, firmware, or any combination thereof that is configured to maintain information about objects (discussed above) corresponding to any of the physical resources 104 and/or logical resources 106 of the cloud resources 102 of the cloud environment 100 (e.g., such as whether objects have been updated), and to provide such information to any number of user interfaces (e.g., the user interface 112, discussed below). As an example, the cloud information service 108 may include any number of computing devices (discussed above). As another example, the cloud information service may be implemented as part of a cloud management service executing in a cluster pod of a cluster maintained by an entity managing, at least in part, the cloud environment 100.

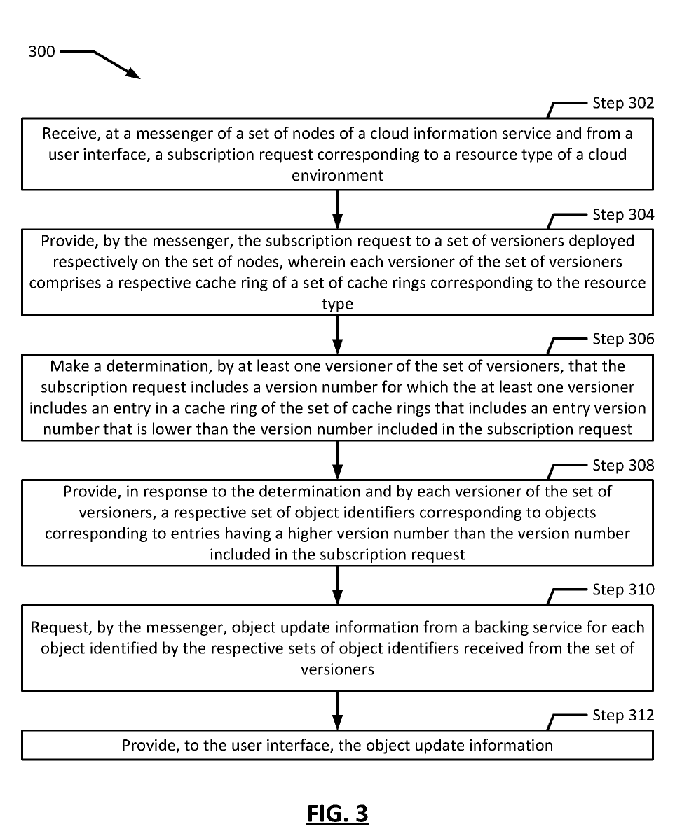

In one or more examples, a cloud information service 108 is configured to create and maintain a set of cache rings for each resource type in the cloud environment 100. There may be any number of sets of cache rings, depending on how many resource types exist in the cloud environment. In one or more examples, the cache rings are used to maintain a versioned history of updates to objects corresponding to the physical resources 104 and/or logical resources 106 of the cloud resources 102, and to provide information about the objects to any number of user interfaces. The cache rings maintained by the cloud information service 108, and the operations of the cloud information service related to maintaining the cache rings and providing information to user interfaces is discussed further in the descriptions of FIGS. 2, and 3, below.

Although FIG. 1 shows the cloud information service 108 as part of the same cloud environment 100 as the cloud resources 102, the cloud information service 108 may instead be deployed separate from, and operatively connected to, the cloud environment 100. Additionally, although FIG. 1 shows only a single cloud information service 108, the system may include any number of cloud information services without departing from the scope of examples disclosed herein.

In one or more examples, the system includes any number of users (e.g., the user 110). In one or more examples, the user 110 is any entity (e.g., a human, a software application, and the like) that seeks to access information about any of the cloud resources 102 of the cloud environment 100. In one or more examples, information about any of the cloud resources 102 of the cloud environment 100 may be obtained by the user 110 via one or more user interfaces (e.g., the user interface 112).

In one or more examples, the user interface 112 is any hardware, software, firmware, or any combination thereof that is configured to allow the user 110 to view or otherwise obtain information about all or any portion of the cloud resources 102 of the cloud environment 100. In one or more examples, the user interface 112, at least some of the time, is operatively connected to the cloud information service 108. A given user (e.g., the user 110) may access the user interface 112 to view information about the various resources (e.g., the cloud resources 102) that exist in the cloud environment 100. Any number of users using any number of user interfaces may exist that desire to see information about resources in a particular cloud environment.

In one or more examples, when the user 110 initiates (e.g., opens, executes, connects to, and the like) the user interface 112 for viewing information about resources in the cloud environment 100 for the first time, subscription requests may be sent to a cloud information service 108 that is operatively connected to the cloud resources 102. A particular subscription request may correspond to a given resource type, and, thus, any number of subscription requests may be sent from the user interface 112 to the cloud information service 108, depending on the number of resource types in the cloud resources 102 and/or the number of resource types about which the user 110 is seeking information via the user interface 112. Such subscription requests may also occur each time the user interface 112 reconnects to the cloud information service 108 (e.g., after a disconnect).

The user interface 112 may remain subscribed after a subscription request as long as the user interface 112 remains connected to the cloud information service 108. In response to the subscription request, the cloud information service 108 may access information about the cloud resources 102, and provide the information to the user interface 112, and provide updates for as long as the user interface 112 maintains the connection, and, thus, remains subscribed.

While FIG. 1 shows a particular configuration of components, other configurations may be used without departing from the scope of examples described herein. For example, although FIG. 1 shows certain components as part of the same device, component, and/or infrastructure, any of the components may be grouped in sets of one or more components which may exist and execute as part of any number of separate and operatively connected devices. As another example, a single component may be configured to perform all, or any portion of the functionality performed by the all or any portion of the components shown in FIG. 1. Accordingly, examples disclosed herein should not be limited to the configuration of components shown in FIG. 1.

FIG. 2 shows a block diagram of a high availability system for providing information about cloud resources, in accordance with one or more examples disclosed herein. As shown in FIG. 2, the system includes a backing service 214, and a cloud information service 208. The backing service may include an object storage 216. The object storage 216 may include any number of objects (e.g., object A 222, object N 224), each of which may be one of any number of resource types (e.g., resource type A 218, resource type N 220). The cloud information service 208 may include any number of nodes (e.g., node A 226, node B 228, node C 230). A node (e.g., the node A 226, the node B 228, the node C 230) may include a versioner (e.g., versioner A 232 of the node A 226, versioner B 234 of the node B 228, versioner C 236 of the node C 230). A node (e.g., the node A 226, the node B 228, the node C 230) may also include zero or more messengers (e.g., messenger A 238 of the node A 226, messenger C-1 240 and messenger C-2 242 of the node C). Each of these components is discussed below.

In one or more examples, the backing service 214 is the same or substantially similar to the backing service 114 shown in FIG. 1 and discussed above. As such, the backing service may include any number of APIs, monitoring tools, management tools, and the like (not shown) that are configured to actively or passively monitor cloud resources (e.g., the cloud resources 102 of FIG. 1) and obtain metadata about the resources.

In one or more examples, the metadata about each resource instance in the cloud resources is maintained as part of an object (e.g., the object A 222, the object N 224). In one or more examples, the backing service 214 is configured to update the metadata stored in the objects as the information about the corresponding resource instance changes.

The backing service 214 may be operatively connected to each of the nodes (discussed further below) of the cloud information service 208. As such, the backing service 214 may be operatively connected to the versioners (discussed further below) and the messengers (discussed further below) of the nodes of the cloud information service 208.

In one or more examples, the object storage 216 is a data repository of any type for storing objects that include metadata about resource instances in the cloud resources (e.g., the cloud resources 102 of FIG. 1). The object storage 216 may include any number of storage devices configured to store data of any type or format in any number of data structures of any type. Although FIG. 2 shows the object storage 216 as part of the backing service 214, in some examples, all or any portion of the object storage 216 may be separate from, and operatively connected to, the backing service 214 without departing from the scope of examples disclosed herein.

In one or more examples, as discussed above, cloud resources (e.g., the cloud resources 102 of FIG. 1) may be classified as any number of resource types (e.g., the resource type A 218, the resource type N 220). Examples of resource types include, but are not limited to, servers, network devices, storage devices, data structures, enclosures, clusters, pods, containers, microservices, virtual machines, buckets (e.g., collections of stored data), and the like. Other examples of resource types may exist within the cloud resources without departing from the scope of examples disclosed herein.

In one or more examples, a particular resource type (e.g., the resource type A 218, the resource type N 220) may include any number of resource instances of the resource type, and each resource instance may have a corresponding object (e.g., the object A 222, the object N 224). As discussed above, an object (e.g., the object A 222, the object N 224) may be a collection of metadata about a particular resource instance in the cloud resources. There may be any number of objects of a particular resource type (e.g., millions of buckets, each corresponding to separate objects) in the cloud resources. Although FIG. 2 shows objects grouped by resource type, and all objects of all resource types stored in the same object storage 216, any other scheme for organizing the objects may be used, and the objects may be stored in any number of separate object storages, and grouped in any manner, without departing from the scope of examples disclosed herein.

In one or more examples, when an update to an object (e.g., the object A 222, the object N 224) in the object storage 216 occurs (e.g., metadata about the resource instance corresponding to the object is updated, the object is deleted, and the like), the backing service 214 may be configured to provide a notification of the update to the set of versioners (e.g., the versioner A 232, the versioner B 234, the versioner C 236) on the set of nodes (e.g., the node A 226, the node B 228, the node C 230) of the cloud information service 208. The notification may include, but is not limited to, a unique identifier of the object that was updated, an identification of the resource type, and an update notification attempt number (discussed further below).

The cloud information service 208 shown in FIG. 2 may be the same as or substantially similar to the cloud information service 108 shown in FIG. 1 and discussed above. In one or more examples, the cloud information service may be implemented on one or more computing devices (discussed above in the description of FIG. 1 and below in the descriptions of FIGS. 4, and 5). As an example, the cloud information service 208 may be implemented as all or any portion of a container cluster (e.g., a Kubernetes cluster).

In one or more examples, the cloud information service 108 includes a number of nodes. In the example shown in FIG. 2, the cloud information service 108 includes three nodes, the node A 226, the node B 228, and the node C 230. In one or more examples, each of the nodes (e.g., 226, 228, 230) may be all or any portion of a computing device (e.g., a physical computing device, a virtual machine, a container, and the like). In one or more examples, each of the nodes (e.g., 226, 228, 230) are operatively connected to the backing service 214, and may also be operatively connected to any number of user interfaces (not shown), such as, for example, the user interface 112 shown in FIG. 1 and discussed above.

In one or more examples, each node (e.g., 226, 228, 230) includes a versioner. In the example shown in FIG. 2, the node A 226 includes the versioner A 232, the node B 228 includes the versioner B 234, and the node C 230 includes the versioner C 236. In one or more examples, each versioner (e.g., 232, 234, 236) is implemented on at least a portion of a computing device (e.g., a portion of the node 226, 228, or 230). As an example, a versioner (e.g., 232, 234, 236) may be implemented as one or more container(s). As each node (e.g., 226, 228, 230) includes a respective versioner (e.g., 232, 234, 236), the set of nodes includes a set of versioners, which may provide redundancy among the versioners, and, thus, redundancy among sets of cache rings maintained by the versioners. As discussed further below, in one or more examples, the versioners (e.g., 232, 234, 236) are configured to communicate with the backing service 214 (e.g., from which update information is received) and with the one or more messengers (e.g., the messenger A 238, the messenger C-1 240, the messenger C-2 242).

The versioners (e.g., 232, 234, 236) may be configured to maintain sets of cache rings for different resource types within a cloud environment (e.g., the cloud environment 100 of FIG. 1). A particular cache ring may include entries corresponding to updates of objects that correspond to resource instances (e.g., information indicating that an object metadata update has occurred).

The cache rings for a given resource type may be distributed across the set of versioners (e.g., 232, 234, 236) deployed on a set of nodes (e.g., 226, 228, 230) to provide redundancy. In such a scenario, each object of a given resource type may be associated with a primary node and a secondary node of the set of nodes that include a cache ring for the resource type, with the total number of objects of the resource type being substantially equitably distributed among the set of nodes as primary nodes for the objects. Thus, in one or more examples, for a given resource type, the cloud information service 108 may implement a set of cache rings maintained by a set of versioners (e.g., 232, 234, 236) on the set of nodes (e.g., 226, 228, 230), with one versioner being a primary owner versioner, one versioner being a secondary owner versioner, and other versioners being non-owner versioners for each particular object corresponding to a particular instance of a resource of a resource type to which the set of cache rings corresponds, with the primary ownership (and secondary ownership) of objects being distributed across the set of versioners. There may be any number of cache rings on a given node (and managed by the versioner on that node), depending on how many resource types exist in the cloud environment (e.g., the cloud environment 100 of FIG. 1).

The following description, for the sake of clarity, will focus on one set of cache rings for one resource type. However, one of ordinary skill in the art will appreciate that the description of a set of cache rings applies to any number of sets of cache rings for any number of resource types in a cloud environment, and that a cloud information service (e.g., the cloud information service 208) may use the various sets of cache rings to provide information to a user interface (e.g., the user interface 112 of FIG. 1) about any number of resource types of a cloud environment.

In one or more examples, a cache ring includes entries corresponding to updates of objects corresponding to instances of resources of a resource type. A particular cache ring maintained by a versioner (e.g., 232, 234, 236) on a node (e.g., 226, 228, 230) may be implemented in memory (e.g., rather than some form of persistent storage). A cache ring may have entries that are added by the versioners (e.g., 232, 234, 236) as information about updates are received from the backing service 214. The versioners (e.g., 232, 234, 236) may be provided information each time an object corresponding to a resource in the cloud environment (e.g., the cloud environment 100 of FIG. 1) is updated.

As an example, when the firmware of an enclosure is updated, the object corresponding to the enclosure may be updated to reflect the new firmware version. As another example, when access permissions for a bucket are updated, the object corresponding to the bucket may be updated to reflect the new access policy. As another example, when the number of pods of containers used to implement an application increases, the object corresponding to the container deployment may be updated with the new number of pods. Other updates to the resources may cause updates to corresponding objects without departing from the scope of examples disclosed herein. In one or more examples, each such update may cause the backing service 214 to communicate to the set of versioners (e.g., 232, 234, 236) a notification indicating that an update to the object has occurred.

The versioners (e.g., 232, 234, 236) may receive information about object updates using any manner of receiving information. As an example, the versioners (e.g., 232, 234, 236) may receive information about container deployments via a Kubernetes application programming interface (API) within the backing service 214 providing information based on a custom resource definition (CRD). As another example, various APIs, monitoring tool, management tools, and the like may exist within the backing service 214 and be configured to provide information about other resources (e.g., buckets, physical devices, logical components, and the like) of a cloud environment (e.g., the cloud environment 100 of FIG. 1).

In one or more examples, each time the versioners (e.g., 232, 234, 236) are notified that an object (e.g., 222, 224) has been updated, the notification may be provided (e.g., from an API of the backing service 214 maintaining objects and monitoring object changes) to each versioner maintaining a cache ring for the resource type to which the object corresponds. Of the set of versioners (e.g., 232, 234, 236), one of the versioners may be a primary versioner for the particular object, and another versioner may be the secondary versioner for the object, with all other versioners being non-owner versioners for the object. As an example, for the object A 222 of the resource type A 218, the versioner A 232 may be the primary owner, the versioner B 234 may be the secondary owner, and the versioner C 236 may be a non-owner versioner.

Which versioner (e.g., 232, 234, 236) is the primary versioner for an object (e.g., 222, 224), and which versioner is the secondary versioner for an object, may be deterministically decided using any suitable technique. As an example, each object may have a unique identifier (e.g., ‘enclosures/enclosure-0027’). In such an example, the primary versioner for the object may be determined by executing a hash function on the unique object name, and taking the result modulo the number of nodes in the set of nodes (e.g., primary node id = [hash[identifier]] % [number of nodes]). The secondary versioner for the object may be determined by adding one to an identifier of the node of the primary versioner (e.g., secondary node id = [primary node id +1] % [number of nodes]), so that the secondary versioner is always on the next node in a listing of nodes after the node of the primary versioner (e.g., when the primary versioner on node 0, the secondary versioner is node 1, when the primary versioner is on node 1, the secondary versioner is on node 2, and the like).

In one or more examples, when an object (e.g., 222, 224) is updated, the backing service 214 is configured to send a notification to each of the set of versioners (e.g., 232, 234, 236) of the cloud information service 208. The notification may include an attempt number indicating a number of times the backing service has sent the notification before receiving an acknowledgement of receipt by a versioner (discussed further below). In one or more examples, in response to receiving a notification of an object update, which includes a unique identifier of the object, each versioner (e.g., 232, 234, 236) determines whether it is a primary owner, secondary owner, or a non-owner of the object (e.g., by performing the aforementioned hash function calculations using the unique object name).

In one or more examples, if a versioner (e.g., 232, 234, 236) is not the primary or secondary owner for the object (e.g., the versioner is a non-owner versioner for the object), the received update may be discarded by the non-owner versioner. Additionally, a global version number (not shown) for updates of objects of the resource type may be incremented on the non-owner versioner, so that each versioner maintains a highest version number for any update even when the versioner is not the primary or secondary owner for the object corresponding to the latest update.

In one or more examples, if a versioner (e.g., 232, 234, 236) determines that it is the primary owner for the object (e.g., by performing the aforementioned hash function calculations using the unique object name), the primary owner versioner may add an entry corresponding to the update to a cache ring maintained by the versioner for the resource type to which the object corresponds. The entry may include, at least, an identifier of the object, a version number of the entry added to the cache ring, and other relevant information, such as the update type (e.g., update, deletion, refresh, separator, and the like, which are discussed further below).

In one or more examples, the version number represents a new entry in the set of cache rings for the resource type, and does not correspond to any particular object of the resource type. In one or more examples, the primary owner versioner may also send an acknowledgement to the backing service 214 indicating receipt of the update. In one or more examples, if the primary owner versioner does not send such an acknowledgement (e.g., because the node on which the primary owner versioner is deployed is down, in a degraded state, and the like), the backing service 214 may increment an update notification attempt counter (not shown) maintained by the backing service for the update, and re-send the notification of the update to all versioners. In one or more examples, each re-send will include an incremented attempt number corresponding to the number of attempts of sending the notification that have been performed by the backing service 214, which will continue until a versioner (e.g., either the primary owner versioner or the secondary owner versioner) responds with an acknowledgement of receipt of the update.

In one or more examples, if a versioner (e.g., 232, 234, 236) determines that it is the secondary owner for the object (e.g., by performing the aforementioned hash function calculations using the unique object name), the secondary owner versioner may add an entry corresponding to the update (similar to the adding of an entry discussed above on the primary owner versioner) to a cache ring maintained by the versioner for the resource type to which the object corresponds, unless the secondary owner versioner has already added the entry (e.g., in a case where the backing service is re-sending a previously sent object update notification after not receiving an acknowledgement from the primary owner versioner), in which case the secondary owner versioner may discard the update.

In one or more examples, the secondary owner versioner is configured to monitor the update notification attempt number included in the notification from the backing service 214. The secondary owner versioner may be pre-configured with a threshold attempt number (e.g., ten). In one or more examples, if the secondary owner versioner determines that an attempt number in a notification has reached the threshold attempt number, the secondary owner versioner may respond by sending an acknowledgement of receipt of the notification to the backing service 214 (e.g., because the primary owner versioner has failed to do so for some reason).

In one or more examples, each update to an object (e.g., 222, 224) of the resource type to which the set of cache rings correspond causes the cloud information service to add an entry to the primary and secondary versioner cache rings (as discussed above), up to the configured maximum size of the cache ring (e.g., hundreds, thousands, millions, and the like of entries). In one or more examples, each entry added to a cache ring by the cloud information service includes a unique identifier (e.g., a unique name, a universally unique identifier (UUID), and the like) of the object that was updated, and a version data item. The version data item may include an encoding of the type of entry (discussed below), as well as a representation of the version number for the entry. As an example, the version data item may be a thirty-two bit number, in which the first two bits are used to encode one of four possible entry types and the remaining thirty bits are used to encode the integer value of the version number. In one or more examples, each entry added by the cloud information service to a set of cache rings includes a version number that is increased (e.g., by one) from the previous entry added to the set of cache rings. In one or more examples, for a given resource type, each versioner is aware of the newest version number added to any cache ring of the set of cache rings for the resource type, either by being the primary or secondary owner versioner for the object that was last updated, or by having incremented a global version number (e.g., by a non-owner versioner for the object causing the latest update).

As discussed above, a set of cache rings corresponds to a resource type, and there may be any number of objects of that resource type (e.g., millions of buckets, each corresponding to separate objects). In one or more examples, an update to any object of that resource type causes the cloud information service to add an entry to the appropriate cache ring(s) of the set of cache rings maintained by the set of versioners. In one or more examples, the version number represents a new entry in the set of cache rings, and does not correspond to any particular object of the resource type.

As an example, an update to a first object of a particular resource type may cause the cloud information service to add a first entry to the set of cache rings (in particular, the primary owner versioner cache ring and the secondary owner versioner cache ring) with an identifier of the first object and a version data item that includes two bits to represent the update type and the remaining bits to represent a first version number. The cloud information service may then be notified of an update to a second object of the same resource type. In response, the cloud information service may add a second entry to the set of cache rings with an identifier of the second object and a version data item that encodes the update type and includes a representation a version number incremented from the version number for the previously added entry. Thus, even though the objects were not the same object, the version number increased as the second entry was added to the set of cache rings by the cloud information service, so that the second entry has a higher version number than the first entry.

In one or more examples, there are four types of entries that may be added to the set of cache rings corresponding to a given resource type. In one or more examples, the first type of entry is an update. In one or more examples, an update is when the information in an object (e.g., metadata corresponding to a resource in a cloud environment) changes. As an example, when the firmware of a network component of an enclosure changes, the object may be changed to reflect a version number of the new firmware. In one or more examples, the second type of entry is a deletion. As an example, a resource may be removed from the cloud environment (e.g., a physical device is removed, a container pod is deleted, a bucket is deleted, and the like), and the object corresponding to that resource is deleted.

In one or more examples, the remaining two entry types are separator entries and refresh entries. In one or more examples, separator and refresh are entry types used whenever a full refresh (discussed below) is performed. In one or more examples, as discussed above, a subscription request is received whenever the user interface is accessed by the user so that the user may view information about resources of a cloud environment. As such, a subscription request may be received when a user first uses the user interface and connects to a cloud information service, and also each time a user reconnects to the cloud information service after previously disconnecting from the cloud information service.

In one or more examples, the primary and secondary owner versioners are synchronized so that they remain as current as possible, even when one or the other goes down for any reason. To facilitate such synchronization, the primary and secondary owner versioners may correspond periodically, or based on the occurrence of an event (e.g., one of the nodes including one of the versioners going down, and then coming back up) to determine if either of the versioners do not have the same highest version number for any entries for objects for which they are the primary or secondary owner versioner. In the event that the highest version number included in an entry for an object between the primary and secondary owner do not match, each of the primary and secondary owner versioners may add an entry corresponding to whatever entry between the two versioners for a given object has the highest version number, such that the two versioners have the same highest version number for entries corresponding to a particular object.

In one or more examples, each node (e.g., 226, 228, 230) of the cloud information service 208 includes zero or more messengers. In the example shown in FIG. 2, the node A 226 includes the messenger A 238, and the node C 230 includes the messenger C-1 240 and the messenger C-2 242. In one or more examples, each messenger (e.g., 238, 240, 242) is implemented on at least a portion of a computing device (e.g., on a portion of a node). As an example, a messenger (e.g., 238, 240, 242) may be implemented as one or more container(s).

In one or more examples, the set of messengers (e.g., 238, 240, 242) are distributed across the set of nodes (e.g., 226, 228, 230). As such, a given node may have zero messengers, one messenger, or two or more messengers. In one or more examples, the total number of messengers and the number of messengers per node is scalable depending on factors such as number of incoming subscription requests, resources available on the nodes, and the like.

The messengers (e.g., 238, 240, 242) may be configured to receive subscription requests (e.g., from a user interface, such as the user interface 112 of FIG. 1), interact with the versioners (e.g., 232, 234, 236) to obtain information about updates to objects (e.g., 222, 224) corresponding to resource instances in a cloud environment (e.g., the cloud environment 100 of FIG. 1), interact with the backing service 214 using the update information to obtain updated object metadata, and prepare and send resource information (e.g., the obtained metadata) to subscribed user interfaces.

In one or more examples, a messenger (e.g., 232, 234, 236) may receive a subscription request from a user interface (e.g., the user interface 112 of FIG. 1) when a user accesses the user interface to view information about resources (e.g., the cloud resources 102 of FIG. 1) in a cloud environment (e.g., the cloud environment 100 of FIG. 1). Which particular messenger receives a given subscription request may be determined, for example, by a load balancing policy implemented for load balancing subscription requests among the messengers of the cloud information service 208.

In one or more examples, a subscription request corresponds to at least one resource type (e.g., buckets, enclosures, network devices, and the like). A messenger (e.g., 232, 234, 236) may receive any number of subscription requests from a given user interface, depending on how many different resource types a user is attempting to view information about. As an example, a user of a user interface may be seeking to view information about servers (e.g., a first resource type), and buckets (e.g., a second resource type), which results in the sending of two subscription requests, one for each resource type, or one subscription request that includes both resource types.

In one or more examples, as discussed above, a subscription request is received whenever the user interface is accessed by the user so that the user may view information about resources of a cloud environment. As such, a subscription request may be received when a user first uses the user interface and connects to a cloud information service, and also each time a user reconnects to the cloud information service after previously disconnecting from the cloud information service.

In one or more examples, a subscription request may or may not include a version number. A version number in a subscription request may be a number identifying the last version number received by the user interface corresponding to an update of an object of a particular resource type to which the subscription request pertains. More specifically, in one or more examples, the version number corresponds to the highest version number present in a set of cache rings maintained by the set of versioners (e.g., 232, 234, 238) on the set of nodes of the cloud information service 208 the last time an update corresponding to the resource type was received by the user interface from the cloud information service 208.

In one or more examples, all or any portion of a subscription request may be provided by a messenger (e.g., 238, 240, 242) to the set of versioners (e.g., 232, 234, 238), which may each be configured to: (i) determine whether the subscription request includes a version number; (ii) determine, when the subscription request does include a version number, whether the version number or any lower version number exists in the respective cache ring of the versioner; and (iii) add an identifier of the sender of the subscription request (e.g., a user interface) to a subscriber list (if not already included in the subscriber list). In one or more examples, a subscriber list is a list of all current subscribers for the resource type to which the cache ring corresponds. In one or more examples, each versioner (e.g., 232, 234, 238) maintains a subscriber list, based on subscription requests for the resource type received from messengers. Thus, in one or more examples, each versioner has the same subscriber list for a given resource type.

In one or more examples, if the subscription request does not include a version number (e.g., the first time a user interface communicates a subscription request to the cloud information service), the cloud information service 208 performs a full refresh (discussed further below), which includes obtaining current information about all resource instances of the resource type to which the subscription request pertains, and providing the information to the user interface, along with the highest version number presently in the set of cache rings corresponding to the resource type. Thereafter, so long as the user interface remains subscribed for the resource type (e.g., maintains a connection to the cloud information service), the cloud information service 208 will provide to the user interface, via one or more of the messengers (e.g., 238, 240, 242), any updates that occur for any instances of the resource type.

In one or more examples, if the subscription request does include a version number (e.g., when a user interface is reconnecting to the cloud information service after a disconnect), the messenger may provide the version number to the set of versioners, which each determine whether all entries in their respective cache rings for the resource type include higher version numbers than the version number in the subscription request.

In one or more examples, if each cache ring for the resource type on each versioner (e.g., 232, 234, 236) includes only entries with a higher version number than the version number in the subscription request, the cloud information service 208 performs a full refresh for the resource type. As an example, if a user interface has been disconnected from the cloud information service for a long enough period of time, the entries for updates to objects corresponding to resource instances of a resource type in a set of cache rings may have reached the ends of the cache rings and started again at the beginning of the cache rings, causing older updates (and their respective version numbers) to be overwritten, and thus no longer present in the set of cache rings.

In one or more examples, if one or more of the versioners (e.g., 232, 234, 236) determine that a cache ring maintained for the resource type includes at least some version numbers in entries in the cache ring that are the same as or lower than the version number included in the subscription request, then the cloud information service 208 performs a partial refresh, in which only updates that have occurred that caused entries in the cache rings that have a higher version number than the version number in the subscription request are communicated to the user interface by a messenger (e.g., 238, 240, 242).

In one or more examples, when an entry is added to a cache ring of a primary owner versioner for an object corresponding to a resource of a resource type for which a subscription request was received by a messenger and provided to the set of versioners, and the primary owner versioner has sent an acknowledgement of receipt of the notification of the update to the backing service, the primary owner versioner may send a notification of the update to a messenger, along with a subscriber list. In one or more examples, the subscription list is maintained by the versioners (e.g., 232, 234, 236), rather than by any particular messenger (e.g., 238, 240, 242), thereby allowing the messengers to remain stateless, as the stateful information necessary for implementing the cloud information service 208 (e.g., update information in the cache rings, subscriber list, object metadata, and the like) may be maintained by the versioners (e.g., 232, 234, 236) and/or the backing service 214, rather than by the messengers. In one or more examples, the messenger (e.g., 238, 240, 242) to which a notification of the update is sent may be determined by a load balancing policy implemented to load balance update notifications among the messengers deployed on the various nodes (e.g., 226, 228, 230) of the cloud information service 208.

In one or more examples, in response to receiving an update notification, the selected messenger (e.g., 238, 240, 242) may use an object identifier included in the update notification to query the backing service 214 for the metadata update that caused the cache ring update (e.g., the current metadata in the object), and, after receiving the updated metadata, communicate the updated metadata to the subscribed user interfaces (identified by the subscriber list received along with the update notification), along with the version number of the entry added to the cache ring of the primary owner versioner (or secondary owner versioner).

In one or more examples, when the primary owner versioner has failed to send an acknowledgement to the backing service 214 indicating receipt of an update notification after the threshold attempt number, and the secondary owner versioner has instead sent the acknowledgement to the backing service 214, the secondary owner versioner may send the update notification to a selected messenger (as described above with regards to the primary owner versioner), and the messenger may perform the same actions to provide the update to the subscribed user interfaces. Thus, in one or more examples, user interfaces that have previously sent a subscription request corresponding to a particular resource type, and have maintained a connection to the cloud information service (e.g., maintained an active subscription), may receive updates to objects of the resource type on an on-going basis, even in the event of the failure of one of the nodes (e.g., 226, 228, 230).

In one or more examples, as discussed above, if the subscription request does not include a version number, or if the subscription request include a version number than is lower than any version number of any entries of the set of cache rings for the resource type to which the subscription request corresponds, a full refresh is performed by the cloud information service 208. In one or more examples, a full refresh includes information for all objects of resources corresponding to the resource type. To facilitate a full refresh, each versioner may respond to such a subscription request with a list of object identifiers for which a respective versioner is a primary owner. Such responses may collectively provide the messenger with a list of the object identifiers for the resource type, which the messenger (e.g., 238, 240, 242) may use to query the backing service 214, in order to obtain the current metadata included in objects corresponding to resources of the resource type, which the messenger may then transmit to the user interface in response to the subscription request, thereby performing a full refresh for the resource type.

In one or more examples, when a full refresh is performed, the cloud information service 208 may add a set of entries to the set of cache rings corresponding to a resource type to which the updated object belongs. The set of entries added when a full refresh is performed start with a first separator type entry, then a refresh type entry for all objects of the resource type owned by a versioner (e.g., as the primary or secondary owner), and then a second separator type entry.

As an example, performing the full refresh may include updating the cache rings of the versioners to ensure that the set of cache rings collectively include a current entry for each object of the resource type. In one or more examples, the cloud information service adds an entry to the set of cache rings with a separator type, then entries for all objects of the resource type to which the cache rings correspond (e.g., the objects for which a versioner is a primary or secondary versioner are added to their respective cache rings), with each such entry having a refresh entry type, and then another entry with a separator entry type, with the first separator entry of each cache ring, each of the refresh entries, and the second separator entry of each cache ring each having an increasing version number, and collectively representing a full refresh.

In one or more examples, the versioners (e.g., 232, 234, 236) then check to determine whether any updates to any objects have occurred during the time full refresh was being performed, and the separator and refresh entries were being added to their respective cache rings. In one or more examples, if there were no updates that occurred during that time, a messenger (e.g., 238, 240, 242) sends the information corresponding to each refresh entry to the user interface in one or more messages of any type (e.g., data packets over a network). In one or more examples, the information corresponding to a refresh entry is the metadata about the resource to which an object corresponds, which the messenger obtains from the backing service 214.

In one or more examples, the messenger (e.g., 238, 240, 242) uses the unique identifiers (which are included in the entries in the cache rings) of the objects to obtain the information from the objects using whatever method of obtaining such information is appropriate for the resource type (e.g., Kubernetes API for objects corresponding to a container deployment, other APIs for objects corresponding to physical resources, and the like). In one or more examples, the information from the objects is sent via one or more messages, and used to update the user interface from which the subscription request was received that caused the full refresh.

In one or more examples, if any updates to objects were added to the cache ring after the last separator entry of the full refresh, but before the full refresh is completed, the cloud information service 208 updates a list of objects to reflect a change to whatever the new version number of the one or more objects that were updated so that the cloud information service 208 is aware of the newest version number in the cache rings corresponding to objects being sent to the user interface as part of the full refresh. In one or more examples, the newest version number for an object is always sent to the user interface, as the cloud information service 208 and the backing service 214 may not maintain any history of the state of the object after an object is updated.

In one or more examples, if another subscription request is received (e.g., from another user using another user interface) that requires a full refresh before the cloud information service 208, via one of the messengers (e.g., 238, 240, 242) sends the object information to the user interface based on the first subscription request that required a full refresh, the cloud information service may start a full refresh (as described above) in response to the subsequent subscription request. However, in that case, in one or more examples, the cloud information service 208 will skip the separator entries and the refresh entries of the later full refresh when determining if any changes occurred to objects during the first full refresh.

In one or more examples, if a disconnect occurs during a full refresh (e.g., a user interface unexpectedly disconnects from the cloud information service 208), when the user interface reconnects, and a new subscription request is received, the new subscription request will include a version number which is the highest version number that the user interface received during the attempted full refresh. In one or more examples, in that case, the cloud information service 208 will resume the full refresh by starting with the next version number after the version number received in the new subscription request. In one or more examples, the full refresh is complete when all object information for all objects of the resource type to which the cache rings correspond, including any updates that occurred before the full refresh completes, are sent to the user interface, along with the highest version number in the cache rings of any entry for any object that was sent as part of the full refresh.

In one or more examples, if a messenger (e.g., 238, 240, 242) does not receive a response from one or more versioners (e.g., 232, 234, 236) in response to a subscription request, then the messenger may request update information from secondary owner versioners for each object owned by the one or more primary owner versioners that failed to respond. As discussed above, the secondary owner versioner may be determined relative to the primary owner versioner. As such, the request from the messenger may be sent to the secondary owner versioner by the messenger. As an example, when the secondary owner versioner is the versioner deployed on a node having an identifier incremented by one from an identifier of the primary owner versioner node, the request may be sent to the versioner on that node.

In one or more examples, the secondary owner versioner, which has maintained a current set of updates in its cache ring for objects for which it is the secondary owner (as discussed above), may respond to such a request with the update information for the object, thereby allowing the messenger to have a complete list of updated objects, even when the primary owner versioner of one or more objects has failed to respond (e.g., because it has failed, become disconnected, and the like), providing redundancy among the set of versioners for any object of the resource type to which a subscription request corresponds.

In one or more examples, a similar process may be performed when a subscription request is received that include a version number, where at least one versioner (e.g., 232, 234, 236) includes a version number lower than the version number received in the subscription request. Specifically, each versioner (e.g., 232, 234, 236) may respond to the messenger (e.g., 238, 240, 242) with a list of object identifiers corresponding to entries having a version number higher than the version number included in the subscription request, which, in aggregate, may be less than all of the objects of the resource type, which may be referred to as a partial refresh.

The messenger (e.g., 238, 240, 242) may then use the reduced set of object identifiers to query the backing service 214 to obtain the object updates only for the objects (e.g., 222, 224) that have been updated after the update that led to an entry having the version number included in the subscription request. The updated resource information for this reduced set may then be provided from the messenger (e.g., 238, 240, 242) as an update to the user interface, which may be less information than would have been provided had a full refresh been performed.

While FIG. 2 shows a particular configuration of components, other configurations may be used without departing from the scope of examples described herein. For example, although FIG. 2 shows certain components as part of the same device, component, and/or infrastructure, any of the components may be grouped in sets of one or more components which may exist and execute as part of any number of separate and operatively connected devices. As another example, a single component may be configured to perform all, or any portion of the functionality performed by the all or any portion of the components shown in FIG. 2. As another example, rather than the particular configuration shown in FIG. 2, the system may include any number of backing services, any number of nodes, any number of versioners, any number of messengers, any number of versioners on a particular node, and any number of messengers on a particular node, and the like. Accordingly, examples disclosed herein should not be limited to the configuration of components shown in FIG. 2.

FIG. 3 illustrates an overview of an example method 300 for providing information about cloud resources from a high availability cloud information service, in accordance with one or more examples disclosed herein.

The method 300 may be performed, at least in part, by one or more devices and/or components of the system shown in FIGS. 1 and/or in FIG. 2. As such, all or any portion of the method 300 may be performed, for example, by a cloud information service (e.g., the cloud information service 108 of FIG. 1, the cloud information service 208 of FIG. 2), a versioner (e.g., the versioners 232, 234, and 236 of FIG. 2), a messenger (e.g., the messengers 238, 240, 242 of FIG. 2), and/or a backing service (e.g., the backing service 114 of FIG. 1, the backing service 214 of FIG. 2).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3 and/or steps not shown in FIG. 3.

In Step 302 the method 300 includes receiving, at a messenger (e.g., one of the messengers 238, 240, or 242 of FIG. 2) of a set of nodes (e.g., one of the nodes 226, 228, or 230 of FIG. 2) of a cloud information service (e.g., the cloud information service 108 of FIG. 1, the cloud information service 208 of FIG. 2) and from a user interface (e.g., the user interface 112 of FIG. 1), a subscription request corresponding to a resource type of a cloud environment (e.g., the cloud environment 100 of FIG. 1). The messenger that receives the subscription request may be selected by a load balancer configured within the cloud information service to load balance subscription requests among messengers. A particular subscription request may or may not include a version number. A version number may indicate the highest version of an entry in any of a set of cache rings corresponding to the resource type and maintained by the cloud information service. In one or more examples, the version number, when included in a subscription request, was previously provided to the user interface from a messenger of the cloud information service the last time an update was sent to the user interface. The subscription request may be received using any suitable form of receiving information (e.g., as one or more network data units transmitted over a network).

In Step 304 the method 300 includes providing, by the messenger, the subscription request to a set of versioners (e.g., the versioners 232, 234, and 236 of FIG. 2) deployed respectively on the set of nodes. Each versioner of the set of versioners may include a respective cache ring of a set of cache rings corresponding to the resource type. In one or more examples, each object of a resource type is associated with one primary owner versioner and one secondary owner versioner among the set of versioners, with the other versioners being non owner versioners for the object. The primary and secondary owners for a particular object may deterministically decided, as discussed above in the descriptions of FIGS. 1, and 2.

In one or more examples, the subscription request includes an identification of the resource type. The subscription request may also include a version number. In one or more examples, if the subscription request does not include a version number, a full refresh is performed. In one or more examples, a full refresh includes each versioner sending to the messenger a list of object identifiers of objects of the resource type for which it is a primary owner versioner. In one or more examples, if one or more versioners do not respond to the messenger, the messenger may identify one or more secondary owner versioners, and request the object identifier list from the one or more secondary owner versioners, so that the messenger receives a complete list of objects of the resource type, even of one or more nodes that include one or more primary owner versioners are unavailable for any reason. In one or more examples, a full refresh may also be performed when the version number included in the subscription request is lower than any version number of any entry in any cache ring of the set of cache rings.

In Step 306 the method 300 includes making a determination, by at least one versioner of the set of versioners, that the subscription request includes a version number for which the at least one versioner includes an entry in a cache ring of the set of cache rings that includes an entry version number that is lower than the version number included in the subscription request. In one or more examples, each versioner includes a cache ring corresponding to the resource type. In one or more examples, when the subscription request includes a version number, each versioner performs a check of the entries in their respective cache rings using the version number to determine if any entries include a same or lower version number than the version number in the subscription request.

In one or more examples, entries are added to cache rings whenever an update to an object occurs (e.g., the metadata of a resource changed, the resource was removed from the cloud environment and the corresponding object was deleted, and the like). The object update may cause a backing service to send an update notification to the set of versioners. The non-owner versioners may discard the update and increment a global version number counter. The primary and secondary owner versioners may add an entry to their respective cache rings to indicate the update. The entries may include an object identifier, an entry type (e.g., update, delete, separator, refresh), and a version number, incremented from the last update entry added to any cache ring of the set of cache rings.

The primary owner versioner may respond to the update notification by sending an acknowledgement of receipt to the backing service. In one or more examples, if the primary owner versioner does not send such an acknowledgement for any reason, the backing service may re-send the update notification, and increment an attempt counter. The backing service may re-send the update notification until a versioner responds with an acknowledgement. The secondary owner versioner for an object may discard updates after the first one, which caused the secondary owner versioner to add an entry for the update to its cache ring. In one or more examples, the update notification includes the attempt number. In one or more examples, if the attempt number reaches a pre-configured threshold, the secondary owner versioner, which is configured to monitor the attempt number, may be configured to respond to the backing service with an acknowledgement of receipt of the update notification.

In one or more examples, when an entry is added to the set of cache rings, the primary owner versioner for the object that was updated may send a notification of the update to a messenger, along with a copy of a subscriber list that includes identifiers of user interfaces subscribed to the cloud information service for the resource type of the object. The subscriber list may be maintained by each versioner, allowing the messengers to remain stateless. The versioners may update the subscriber list as subscription requests are received from messengers.

In Step 308 the method 300 includes providing, in response to the determination and by each versioner of the set of versioners, a respective set of object identifiers corresponding to objects corresponding to entries having a higher version number than the version number included in the subscription request. In one or more examples, the sets of object identifiers sent by the versioners are collectively less than the full set of object identifiers of the resource type when the version number in the subscription request is the same as or higher than at least some of the version numbers in the set of cache rings.

In one or more examples, the versioners collectively sending this reduced set of object identifiers is part of performing, by the cloud information service, a partial refresh. In one or more examples, a partial refresh includes only sending to the user interface that sent the subscription request updates to metadata of resources (stored in the objects) that have been updated since the last time an update was sent to the user interface.

In one or more examples, the messenger that the versioners send the object identifiers to may or may not be the messenger from which the versioners received the subscription request. In some examples, the messenger to which the versioners sends the object identifiers is selected by a load balancing policy implemented within the cloud information service for load balancing among the messengers which messenger will send the updates to the user interface.

In Step 310 the method 300 includes requesting, by the messenger, object update information from a backing service for each object identified by the respective sets of object identifiers received from the set of versioners. In one or more examples, the messenger may request the object information (e.g., metadata about resources corresponding to the objects) using any suitable technique for requesting information. As an example, the messenger may be configured to interact with an appropriate API of the backing service for the particular resource type to which the subscription request corresponds. In one or more examples, the backing service responds to the request from the messenger by providing object information (e.g., metadata about resource instances) for each object identified by the set of object identifiers.

In Step 312 the method 300 includes providing, to the user interface, the object update information. In one or more examples, the updates are provided to the user interface using any suitable technique for sending information. As an example, the updates may be sent as part of one or more messages included in one or more network data units transmitted using a network.

FIG. 4 illustrates a block diagram of a computing device 400, in accordance with one or more examples disclosed herein. The computing device 400 may be an example of all or any portion of any components shown in FIG. 1 (e.g., the cloud information service 108, the backing service 114) and described above, all or any portion of any components shown in FIG. 2 (e.g., the cloud information service 208; the backing service 214; the nodes 226, 228, 230; the versioners 232, 234, 236; the messengers 238, 240, 242) and described above, and/or of the computing device 500 of FIG. 5, described below. As discussed above in the descriptions of FIGS. 1, 2, and 3 the computing device 400 may be used to implement all or any portion of the various components shown in FIGS. 1, and 2 described above and/or to perform all or any portion of the method 300 shown in FIG. 3 and described above.

The computing device 400 may include one or more processors 402 and memory 404. The memory 404 may include a non-transitory computer-readable medium that stores programming for execution by one or more of the one or more processors 402. In this implementation, one or more modules within the computing device 400 may be partially or wholly embodied, at least in part, as software for performing any functionality described in this disclosure. The computing device 400 may be, for example, configured to perform the method 300 shown in FIG. 3 and described above, by executing instructions included in the memory 404 and executed by the one or more processors 402.

For example, the memory 404 may include instructions 406 to receive, at a messenger of a set of nodes of a cloud information service and from a user interface, a subscription request corresponding to a resource type of a cloud environment (e.g., as described above in reference to Step 302 of FIG. 3).

For example, the memory 404 may include instructions 408 to provide, by the messenger, the subscription request to a set of versioners deployed respectively on the set of nodes, wherein each versioner of the set of versioners comprises a respective cache ring of a set of cache rings corresponding to the resource type (e.g., as described above in reference to Step 304 of FIG. 3).

For example, the memory 404 may include instructions 410 to make a determination, by at least one versioner of the set of versioners, that the subscription request includes a version number for which the at least one versioner includes an entry in a cache ring of the set of cache rings that includes an entry version number that is lower than the version number included in the subscription request (e.g., as described above in reference to Step 306 of FIG. 3).

For example, the memory 404 may include instructions 412 to provide, in response to the determination and by each versioner of the set of versioners, a respective set of object identifiers corresponding to objects corresponding to entries having a higher version number than the version number included in the subscription request (e.g., as described above in reference to Step 308 of FIG. 3).

For example, the memory 404 may include instructions 414 to request, by the messenger, object update information from a backing service for each object identified by the respective sets of object identifiers received from the set of versioners (e.g., as described above in reference to Step 310 of FIG. 3).

For example, the memory 404 may include instructions 416 to provide, to the user interface, the object update information (e.g., as described above in reference to Step 312 of FIG. 3).

FIG. 5 illustrates a block diagram of a computing device 500, in accordance with one or more examples of this disclosure. As discussed above, examples described herein may be implemented, at least in part, using computing devices, and the computing device 500 shown in FIG. 5 may be such a computing device. For example, all or any portion of the components shown in FIG. 1 (e.g., the cloud information service 108, the backing service 114) or FIG. 2 (e.g., the cloud information service 208; the backing service 214; the nodes 226, 228, 230; the versioners 232, 234, 236; the messengers 238, 240, 242) may be implemented, at least in part using a computing device such as the computing device 500, and may include all or any portion of the components of the computing device 500 shown in FIG. 5 and described below.

In one or more examples, a computing device (e.g., the computing device 500) is any device, portion of a device, or any set of devices capable of electronically processing instructions and may include, but is not limited to, any of the following: one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. In some examples, a computing device (e.g., the computing device 500) may include any number of homogeneous or heterogeneous processors of any type.

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be a central processing unit (CPU), a multi-core CPU, an application specific integrated circuit (ASIC), a graphics processing unit (GPU), a data processing unit (DPU), a tensor processing units (TPU), an associative processing unit (APU), a vision processing units (VPU), a quantum processing unit (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart or flow diagram may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, a network device, or a processing device (e.g., one or more processors) to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and the like.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components or elements. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms "before", "after", "single", and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, operative connection, and variations thereof, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A system, comprising:
one or more processors; and
one or more non-transitory computer readable media storing instructions which, when executed by the one or more processors, cause the one or more processors to:
receive, at a messenger of a set of nodes of a cloud information service and from a user interface, a subscription request corresponding to a resource type of a cloud environment;
provide, by the messenger, the subscription request to a set of versioners deployed respectively on the set of nodes, wherein each versioner of the set of versioners comprises a respective cache ring of a set of cache rings corresponding to the resource type;
make a determination, by at least one versioner of the set of versioners, that the subscription request includes a version number for which the at least one versioner includes an entry in a cache ring of the set of cache rings that includes an entry version number that is lower than the version number included in the subscription request;
provide, in response to the determination and by each versioner of the set of versioners, a respective set of object identifiers corresponding to objects corresponding to entries having a higher version number than the version number included in the subscription request;
request, by the messenger, object update information from a backing service for each object identified by the respective sets of object identifiers received from the set of versioners; and
provide, to the user interface, the object update information.

2. The system of claim 1, wherein execution of the instructions by the one or more processors further causes the one or more processors to:
receive, from the user interface, a second subscription request;
provide, by the messenger, the second subscription request to the set of versioners;
make a second determination, by respective versioners of the set of versioners, that a second version number included in the second subscription request is lower than a global version number corresponding to the resource type of the second subscription request; and
perform, in response to the second determination, a full refresh.

3. The system of claim 1, wherein the set of versioners comprises a primary owner versioner and a secondary owner versioner for an object of the resource type of the subscription request.

4. The system of claim 3, wherein, when the primary owner versioner of the object is unable to respond to the messenger, execution of the instructions by the one or more processors further causes the one or more processors to:
identify, by the messenger, the secondary owner versioner for the object;
request, by the messenger and from the secondary owner versioner, update information corresponding to the object;
receive, by the messenger, from the secondary owner versioner, and before providing the object update information to the user interface, the update information corresponding to the object,
wherein the update information corresponding to the object comprises an object identifier corresponding to the object; and
obtain, by the messenger and using the object identifier corresponding to the object, a portion of the object update information from the backing service,
wherein the portion of the object update information comprises updated metadata of the object.

5. The system of claim 1, wherein the messenger is one of a set of stateless messengers distributed among the set of nodes.

6. The system of claim 1, wherein the set of cache rings, distributed among the set of versioners deployed on the set of nodes, corresponds to the resource type.

7. The system of claim 1, wherein execution of the instructions by the one or more processors further causes the one or more processors to:
receive, at each of the set of versioners, an update to a particular object of the resource type;
make a second determination, by each of the set of versioners, whether each versioner is a primary owner versioner or a secondary owner versioner of the particular object; and
add, based on the second determination and by the primary owner versioner and the secondary owner versioner, a new entry to a respective cache ring of the set of cache rings corresponding to the update of the particular object.

8. The system of claim 7, wherein execution of the instructions by the one or more processors further causes the one or more processors to:
transmit, to the backing service and from the primary owner versioner, an acknowledgement that the update for the particular object was added to the respective cache ring of the primary owner versioner.

9. The system of claim 7, wherein execution of the instructions by the one or more processors further causes the one or more processors to:
making a third determination, by the secondary owner versioner, that an attempt number included in the update is equal to or greater than a threshold attempt number; and
transmitting, in response to the third determination and to the backing service, and from the secondary owner versioner, an acknowledgement that the update for the particular object was added to the respective cache ring of the secondary owner versioner.

10. A computer-implemented method, comprising:
receiving, at a messenger of a set of nodes of a cloud information service and from a user interface, a subscription request corresponding to a resource type of a cloud environment;
providing, by the messenger, the subscription request to a set of versioners deployed respectively on the set of nodes, wherein each versioner of the set of versioners comprises a respective cache ring of a set of cache rings corresponding to the resource type;
making a determination, by at least one versioner of the set of versioners, that the subscription request includes a version number for which the at least one versioner includes an entry in a cache ring of the set of cache rings that includes an entry version number that is lower than the version number included in the subscription request;
providing, in response to the determination and by each versioner of the set of versioners, a respective set of object identifiers corresponding to objects corresponding to entries having a higher version number than the version number included in the subscription request;
requesting, by the messenger, object update information from a backing service for each object identified by the respective sets of object identifiers received from the set of versioners; and
providing, to the user interface, the object update information.

11. The computer-implemented method of claim 10, further comprising:
receiving, from the user interface, a second subscription request;
providing, by the messenger, the second subscription request to the set of versioners;
making a second determination, by respective versioners of the set of versioners, that a second version number included in the second subscription request is lower than a global version number corresponding to the resource type of the second subscription request; and
performing, in response to the second determination, a full refresh.

12. The computer-implemented method of claim 10, wherein the set of versioners comprises a primary owner versioner and a secondary owner versioner for an object of the resource type of the subscription request.

13. The computer-implemented method of claim 12, wherein, when the primary owner versioner of the object is unable to respond to the messenger, the computer-implemented method further comprises:
identifying, by the messenger, the secondary owner versioner for the object;
requesting, by the messenger and from the secondary owner versioner, update information corresponding to the object;
receiving, by the messenger, from the secondary owner versioner, and before providing the object update information to the user interface, the update information corresponding to the object,
wherein the update information corresponding to the object comprises an object identifier corresponding to the object; and
obtaining, by the messenger and using the object identifier corresponding to the object, a portion of the object update information from the backing service,
wherein the portion of the object update information comprises updated metadata of the object.

14. The computer-implemented method of claim 10, wherein the messenger is one of a set of stateless messengers distributed among the set of nodes.

15. The computer-implemented method of claim 10, wherein the set of cache rings, distributed among the set of versioners deployed on the set of nodes, corresponds to the resource type.

16. The computer-implemented method of claim 10, further comprising:
receiving, at each of the set of versioners, an update to a particular object of the resource type;
making a second determination, by each of the set of versioners, whether each versioner is a primary owner versioner or a secondary owner versioner of the particular object; and
adding, based on the second determination and by the primary owner versioner and the secondary owner versioner, a new entry to a respective cache ring of the set of cache rings corresponding to the update of the particular object.

17. The computer-implemented method of claim 16, further comprising:
transmitting, to the backing service and from the primary owner versioner, an acknowledgement that the update for the particular object was added to the respective cache ring of the primary owner versioner.

18. The computer-implemented method of claim 16, further comprising:
making a third determination, by the secondary owner versioner, that an attempt number included in the update is equal to a threshold attempt number; and
transmitting, in response to the third determination, to the backing service, and from the secondary owner versioner, an acknowledgement that the update for the particular object was added to the respective cache ring of the secondary owner versioner.

19. A non-transitory computer-readable medium storing programming for execution by one or more processors, the programming comprising instructions to:
receive, at a messenger of a set of nodes of a cloud information service and from a user interface, a subscription request corresponding to a resource type of a cloud environment;
provide, by the messenger, the subscription request to a set of versioners deployed respectively on the set of nodes, wherein each versioner of the set of versioners comprises a respective cache ring of a set of cache rings corresponding to the resource type;
make a determination, by at least one versioner of the set of versioners, that the subscription request includes a version number for which the at least one versioner includes an entry in a cache ring of the set of cache rings that includes an entry version number that is lower than the version number included in the subscription request;
provide, in response to the determination and by each versioner of the set of versioners, a respective set of object identifiers corresponding to objects corresponding to entries having a higher version number than the version number included in the subscription request;
request, by the messenger, object update information from a backing service for each object identified by the respective sets of object identifiers received from the set of versioners; and
provide, to the user interface, the object update information.

20. The non-transitory computer-readable medium of claim 19, wherein the set of versioners comprises a primary owner versioner and a secondary owner versioner for an object of the resource type of the subscription request.
